(19) United States
(12) Patent Application Publication
(10) Pub. No.: US 2016/0046771 A1
(43) Pub. Date: Feb. 18, 2016

(54) OLIGOMER-GRAFTED NANOFILLERS AND ADVANCED COMPOSITE MATERIALS

(71) Applicants: ADAMA MATERIALS, INC., E. Palo Alto, CA (US); REGENTS OF THE UNIVERSITY OF MINNESOTA, Minneapolis, MN (US)

(72) Inventors: Francis R. THIBODEAU, Oakland, CA (US); Yuqiang QIAN, New Brighton, MN (US); Andreas STEIN, Saint Paul, MN (US); Christopher W. MACOSKO, Minneapolis, MN (US); Nicholas D. PETKOVICH, Roseville, MN (US)

(21) Appl. No.: 14/777,042

(22) PCT Filed: Mar. 14, 2014
(86) PCT No.: PCT/US14/27858

§ 371 Date: Sep. 15, 2015

Related U.S. Application Data
(60) Provisional application No. 61/791,132, filed on Mar. 15, 2013.

(51) Int. Cl. C08J 5/00; C08J 3/24

(52) U.S. Cl. CPC C08J 5/00; C08J 3/24; C08J 2309/02; C08J 2325/06; C08J 2333/06

(57) ABSTRACT

Oligomer-grafted nanofiller compositions and composites including oligomer-grafted nanofillers are disclosed. An oligomer-grafted nanofiller composition for disposition in a polymer matrix, the polymeric matrix comprising polymers derived from a plurality of polymerizable units, can include a nanoparticle, one or more coupling groups bonded to the nanoparticle; and one or more oligomers bonded to the one or more coupling groups. In an embodiment the oligomer is derived from two or more polymerizable units, at least one polymerizable unit being at least substantially similar to at least one of the polymerizable units of the polymer matrix. In another embodiment the oligomer comprises two or more polymerizable units and improves dispersion, interfacial strength, or both dispersion and interfacial strength between the nano-particle and the polymer matrix. Composites and methods are also disclosed.

### CROSS REFERENCE TO RELATED APPLICATIONS

This application claims priority to U.S. Provisional Patent Application No. 61/791,132, filed Mar. 15, 2013.

### TECHNICAL FIELD

The disclosed inventions are in the field of composite materials and nanomaterials for improving the properties of polymeric materials.

### BACKGROUND

Polymeric composite materials are used in a wide variety of applications, from transportation vehicles to sporting equipment, and a variety of mechanical parts. Owing to their relatively low density and high strength, polymeric composite materials are advantageously used as a replacement for heavier metallic materials. However polymeric composite materials lack certain desirable properties compared to metals, such as high impact strength (e.g., “toughness”), electrical conductivity, and barrier against molecular transport. Previous attempts have been made to include filler particles in the polymeric composite materials to improve these properties. However the mechanical properties of such composite materials often suffer as a result of incompatibility between the filler particle and the polymeric matrix. Accordingly, there is a need to provide filler particles that are more compatible with polymeric matrices. There is also a need to improve the mechanical properties of polymeric composite materials.

### SUMMARY

Provided herein are oligomer-grafted nanofiller compositions for disposition in a polymer matrix, the polymeric matrix comprising polymers derived from a plurality of polymerizable units, the nanofiller composition comprising: a nanoparticle; one or more coupling groups bonded to the nanoparticle; and one or more oligomers bonded to the one or more coupling groups, wherein the oligomers are derived from two or more polymerizable units, at least one polymerizable unit being at least substantially similar to at least one of the polymerizable units of the polymer matrix.

Also provided are oligomer-grafted nanofiller compositions for disposition in a polymer matrix, the polymeric matrix comprising two or more polymerizable units, the nanofiller composition comprising: a nanoparticle; one or more coupling groups bonded to the nanoparticle; and one or more oligomers bonded to the one or more coupling groups, wherein the oligomer comprises two or more polymerizable units and improves dispersion, interfacial strength, or both dispersion and interfacial strength between the nanoparticle and the polymer matrix.

Also provided are composites comprising a composition of an oligomer-grafted nanofiller and polymer composite having a polymer matrix and one or more oligomer-grafted nanofillers dispersed within the polymer matrix. The oligomer-grafted nanofiller can include a nanoparticle, one or more coupling groups bonded to the nanoparticle, and one or more oligomers bonded to the one or more coupling groups.

Furthermore, the present disclosure provides methods for making oligomer-grafted nanofillers and composites. The methods for making oligomer-grafted nanofillers can include grafting a nanoparticle with one or more oligomers to form an oligomer-grafted nanofiller. The methods for making an oligomer-grafted nanofiller can also include reacting a nanoparticle with one or more coupling agent to form a coupling agent-bonded nanoparticle and reacting the coupling agent-bonded nanoparticle with one or more oligomers to form an oligomer-grafted nanofiller.

In further embodiments, there are provided composites, comprising: a polymer matrix; and one or more oligomer-grafted nanofillers dispersed within the polymer matrix, wherein the oligomer-grafted nanofillers comprise a nanoparticle, one or more coupling groups bonded to the nanoparticle, and one or more oligomers bonded to the one or more coupling groups.

Also provided are methods for making composites, comprising dispersing an oligomer-grafted nanofiller in a polymer matrix, wherein the polymer matrix comprises one or more polymerizable units and effectuating bonding between the oligomers and the polymer matrix. The oligomer-grafted nanofiller can include a nanoparticle and one or more oligomers covalently bonded to the nanoparticle, optionally through a coupling agent and the one or more oligomers can be derived from two or more polymerizable units, at least one polymerizable unit can be at least substantially similar to at least one of the polymerizable units of the polymer matrix.

Methods for making a composite are also provided, the methods comprising dispersing an oligomer-grafted nanofiller in a fluid comprising one or more monomers, the oligomer portion of the oligomer-grafted nanofiller being derived from at least one polymerizable unit corresponding to the one or more monomers and polymerizing the monomer.

In addition articles made from the oligomer-grafted nanofiller composite provided herein are also disclosed.

### BRIEF DESCRIPTION OF THE DRAWINGS

The present disclosure is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In addition, the drawings are not necessarily drawn to scale. In the drawings:

FIG. 1 illustrates a method (100) for attaching coupling agents (110) to a nanoparticle (105) to form a nanoparticle that is bonded to one or more coupling agents (115).

FIG. 2 illustrates a method (120) for attaching oligomers (125) to the coupling agents (110) that are attached to a nanoparticle (105) in a nanoparticle that is bonded to one or more coupling agents (115) to form an oligomer-grafted nanofiller (130).

FIG. 3 illustrates a method (200) for attaching a dendritic coupling agent (210) to a nanoparticle (205) to form a nanoparticle that is bonded to one or more dendritic coupling agents (215) and subsequently attaching oligomers (225) to the dendritic coupling agents (210) of the nanoparticle that is bonded to one or more dendritic coupling agents (215) to form an oligomer-grafted nanofiller (230).

FIG. 4 illustrates a method (300) for dispersing oligomer grafted nanofillers (330) including a nanoparticle (305) and oligomers on the surface of the nanoparticle (305) forming an oligomer shell (335), adding the oligomer grafted nanofillers (330) to a solution of monomer (340) and polymerizing the monomers to form a composite material (345). As shown in the embodiment illustrated in FIG. 4, once the monomer solution has been polymerized, there is no visible interface between the polymerized shells (335) of the oligomer-grafted nanofillers (330) and the polymer matrix (350).

FIG. 5 illustrates a method of the functionalization of graphene oxide (GO) using methylene diphenyl diisocyanate (MDI) in a first step and amine-terminated polybutadiene-polyacrylonitrile oligomer (ATBN) in a second step.

FIG. 5A illustrates the chemical structure of ATBN.

FIG. 6 shows the FT-IR spectra of ATBN-GO, GO-NCO, and GO.

FIG. 7 shows the x-ray diffraction spectra of ATBN-GO, MDI-GO, and GO.

FIG. 8 shows (a) modulus, (b) tensile strength, (c) fracture toughness, and (d) fracture energy plots of epoxy nanocomposites.

FIG. 9 shows dynamic mechanical analysis of neat epoxy and epoxy/graphene nanocomposites: (a) storage modulus, E′, and (b) loss modulus, E″.

FIG. 10 shows the TGA and first derivative TGA curves of GO and GA from room temperature to 900° C. in nitrogen.

FIG. 11 shows TEM images of (a) GS1, (b) GS2, (c) GO, and (d) GA. Specimens were prepared from ethanol (a,b,c) or DMF (d) dispersion. The network pattern in (d) is from lacey carbon on the TEM grid.

FIG. 12 shows SEM images of (a) GS1, (b) GS2, (c) GO, and (d) GA powders. GS1 and GS2 specimens were prepared as received from the manufacturer, and GO and GA specimens were prepared after freeze-drying. The scale bar is 2 μm.

FIG. 13 shows the steady shear viscosity of D230 dispersions with 1.16 wt % graphene. The dispersion with 1.16 wt % GS2 is a viscous paste.

FIG. 14 shows TEM images of epoxy nanocomposites with 0.16 wt % of (a) GS1, (b) GS2, (c) GO, and (d) GA.

FIG. 15 shows a scheme for the organic functionalization of GO with oleyl and methacryloyl groups.

FIG. 16 shows the FT-IR spectra of GO, OA-GO and GO-C═C.

FIG. 17 shows XRD patterns of GO, OA-GO and GO-C═C.

FIG. 18 shows TEM images of (a) GO and (b) GO-C═C.

FIG. 19 shows TEM images of UP nanocomposites with (a, b) GO and (c, d) GO-C═C nanofillers.

FIG. 20 shows the relative mechanical properties of UP_GO and UP_GO-C═C nanocomposites. All results were normalized relative to neat UP for easier comparison.

FIG. 21 shows the general synthesis scheme for TMI-GO nanofillers.

FIG. 22 shows the general synthesis scheme for TMI-GO nanofillers further functionalized with alkylamines.

FIG. 23 shows the synthesis scheme for TMI-GO-60° C.-2×-D-Stearyl.

FIG. 24 shows the general composition of a UP resin used in nanocomposite synthesis processes.

FIG. 25 shows the general synthesis scheme for nanocomposites made with TMI-GO nanofillers in UP resin with 45% styrene diluent.

FIG. 26 shows the general synthesis scheme for nanocomposites made with TMI-GO nanofillers in UP resin with 29% styrene+16% MMA mixed diluent.

FIG. 27 shows the general synthesis scheme for nanocomposites made with TMI-GO-60° C.-2×-D-Stearyl nanofiller in UP resin with 45% styrene diluent.

FIG. 28 shows comparisons between various nanocomposites for (a)-(b) toughness, (c) modulus, and (d) strength.

FIG. 29 shows comparisons between nanocomposites with TMI-GO-40° C.-1× in styrene and in a mixed diluent for (a) toughness, (b) modulus, and (c) strength.

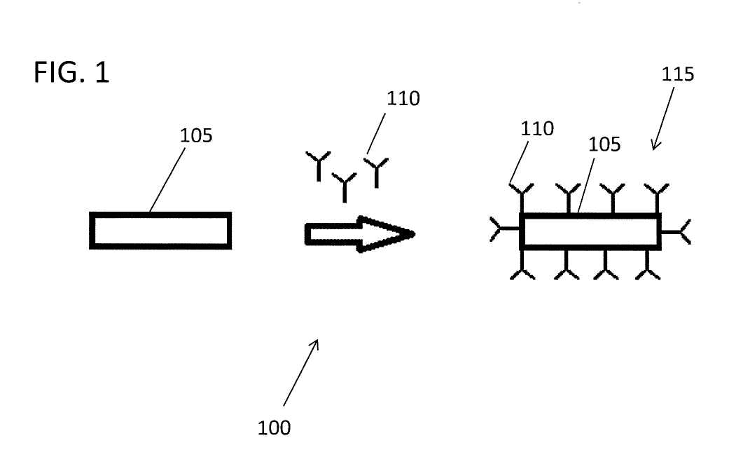

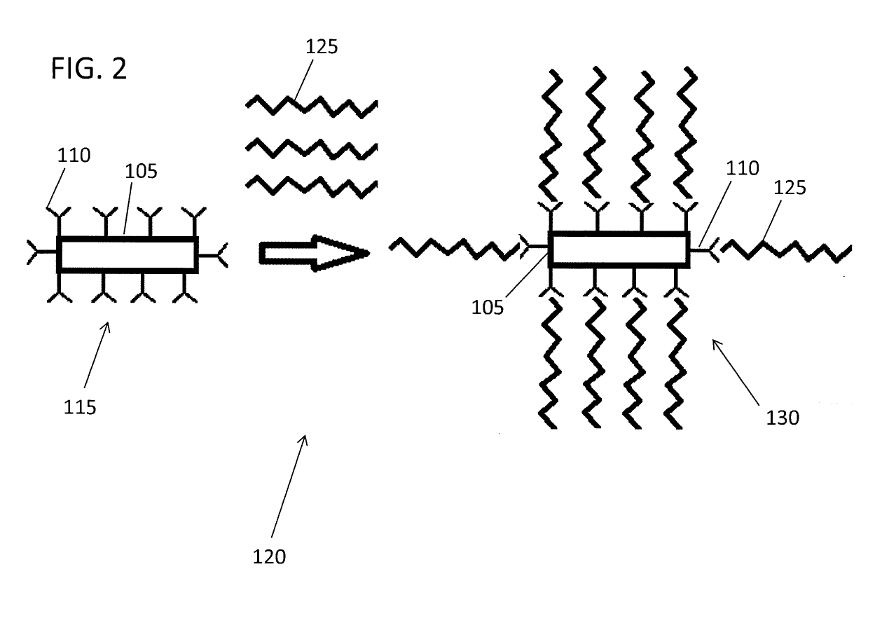

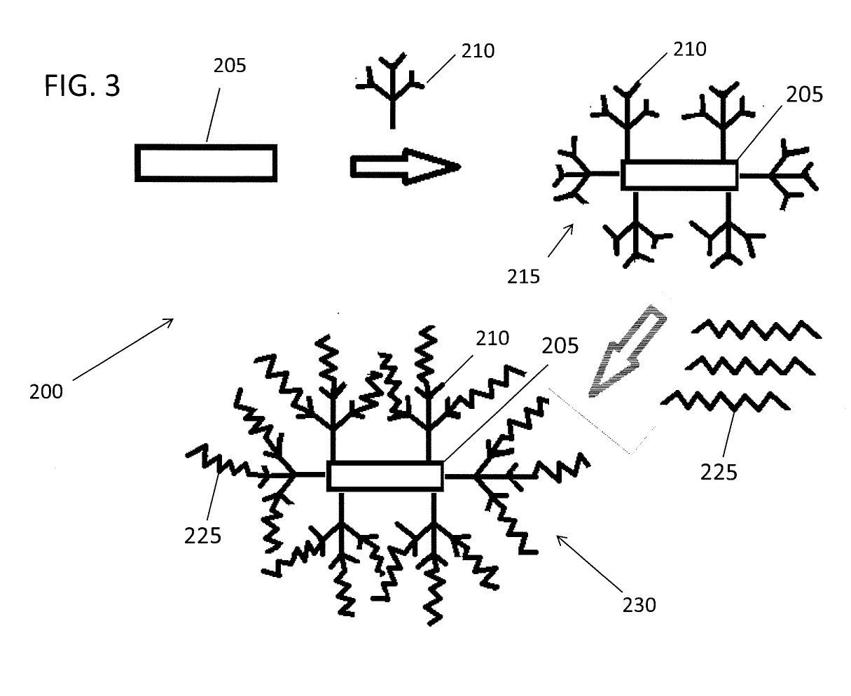

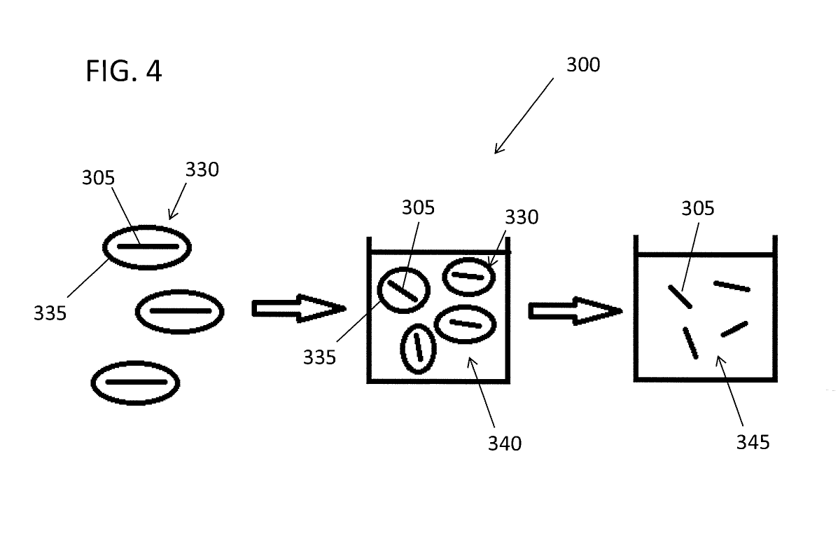

### DETAILED DESCRIPTION OF ILLUSTRATIVE EMBODIMENTS

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using oligomer-grafted nanofillers and composite materials that include oligomer-grafted nanofillers, as well as the oligomer-grafted nanofillers and composite materials that include oligomer-grafted nanofillers themselves, and vice versa.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

Oligomer-grafted nanofiller (OGN) compositions of the invention can be used for disposition in a polymer matrix that includes polymers derived from a plurality of polymerizable units. The nanofiller composition can include a nanoparticle, one or more coupling groups bonded to the nanoparticle, and one or more oligomers bonded to the one or more coupling groups. In an embodiment the oligomers can be derived from two or more polymerizable units where at least one polymerizable unit can be at least substantially similar to at least one of the polymerizable units of the polymer matrix. In another embodiment the oligomer comprises two or more polymerizable units and can improve dispersion, interfacial strength, or both dispersion and interfacial strength between the nanoparticle and the polymer matrix.

Suitable nanofillers (for example, graphene, graphene oxide, carbon nanotubes) can be grafted with single-type or multiple oligomer surface groups that are either identical in composition to the host polymer matrix or otherwise chosen to improve dispersion and/or interfacial strength with the host. Because of the resulting similarity between nanofiller and host matrix, high dispersion of nanofiller in the matrix can be achieved. The strong bond between filler and surface oligomer groups and the strong interactions between surface oligomer groups and the host polymer matrix ensure a strong interface between all components. Good dispersion and strong interfaces can ensure effective load transfer between the polymer matrix and the filler to enhance the toughness, stiffness, and dimensional stability of the composites. The approach also includes grafting a first oligomer type to aid in dispersion or interfacial strength and a second, or greater number of types, to achieve desirable materials properties such as toughening, etc.

Suitable nanoparticles can be selected from any particle having at least one characteristic dimension in the range of from about 1 nm to about 100 nm and that can be used as a filler in a polymer matrix. Suitable nanoparticles used herein can include a carbonaceous material, which, as used herein refers to a material having one or more carbon atoms. Suitable carbonaceous nanoparticles can include, but are not limited to, single-walled carbon nano-tubes, multi-walled carbon nanotubes, carbon nanofibers, graphene sheets, graphene oxide nanoparticles, graphite nanoparticles, fullerene particles, carbon blacks, or activated carbons. Suitable nanoparticles can also include metal oxides, such as silica, layered silicates, clays, ceramics, and layered chalcogenides. Nanoparticles that are useful in the invention can also include any combination or subcombination of the aforementioned materials.

As used herein, the term “coupling group” refers to any chemical functionality that serves to attach an oligomer to the surface of the nanoparticle. A coupling group can also be a reactive group that attaches to another coupling group that is bonded or otherwise attached to the nanoparticle. It is to be understood that the term coupling group, therefore, can refer to the entire moiety that serves to bridge the nanoparticle and one or more oligomers, and the term coupling agent can also refer to any subpart of the moiety that connects the nanoparticle and one or more oligomers. For example, a coupling group can include a first coupling group, also referred to as an anchoring group, that bonds directly to the nanoparticle and a second coupling group that bonds to the anchoring group and serves as the point of attachment for one or more oligomers. The coupling group or anchoring group can be a functionality on the surface of the nanoparticle that is intrinsic to the structure of the nanoparticle. For example, an intrinsic coupling group or anchoring group can include —OH, —COOH, or other reactive functionality, depending on the structure of the nanoparticle. Alternatively, the coupling group or anchoring group can be a reactive species that is attached to a nanoparticle by way of a chemical reaction. In some materials such as, for example, graphene, the density of intrinsic anchoring points can be quite low. It may be increased by chemical treatment that increases the number of intrinsic surface groups. For example, the coupling group or anchoring group can include —OH, —COOH, —NH₂, —C═C, —NCO, epoxide, or other reactive functionality. The coupling group or anchoring group can be bonded to the nanoparticle, such as covalently bonded or ionically bonded. As described above, a coupling group can be attached to the nanoparticle through another coupling group or anchoring group. For example, a coupling group includes, but is not limited to, organic silane, di-isocyanate, di-amine, quaternary amine, or other reactive functionality. The number of anchoring points for attachment of oligomer to the nanoparticle can also be increased by attaching branched surface groups that contain multiple points for attachment to enable dendritic growth. Thus, a coupling group can be dendritic and have multiple reactive sites such that one or more oligomers can be attached to it. Example dendritic coupling groups include, but are not limited to polyamine, polyisocyanate and polyol.

In OGN compositions of the invention, one or more oligomers can be attached to a coupling agent that is attached to a nanoparticle. That is, one oligomer can be bonded to one coupling agent that is bonded to the nanoparticle. Alternatively, more than one oligomer can each be bonded directly to a single coupling agent, or such as to multiple sites on a single coupling agent that is bonded to the nanoparticle, or one oligomer can be bonded directly to more than one coupling agent, such as through multiple sites on the single oligomer. One or more oligomers can be attached to one or more coupling agents by chemical bonding, such as covalent bonding or ionic bonding. For example, multifunctional crosslinking agents comprising n functional groups can be attached to the coupling agent, to provide n−1 functional groups for linking up to n−1 oligomers per coupling agent.

Suitable oligomers can be derived from 2 to about 200 polymerizable units, more preferably from about 10 to about 100 polymerizable units, and even more preferably from about 20 to about 50 polymerizable units. In terms of molecular weight, suitable oligomers can typically have a molecular weight in the range of from about 100 g/mol to about 10,000 g/mol, more preferably in the range of from about 500 g/mol to about 5,000 g/mol, and even more preferably in the range of from about 1000 g/mol to about 2,500 g/mol.

In certain embodiments, suitable oligomers can also refer to a polymer comprising in the range of from about 2 to about 100 polymerizable units. In some embodiments, suitable oligomers for use in OGN compositions of the invention can have from about 2 to about 100 polymerizable units, or from about 2 to about 80 polymerizable units, or from about 2 to about 60 polymerizable units, or from about 5 to about 40 polymerizable units, or from about 10 to about 20 polymerizable units. Oligomers can also be referred to herein as a low-molecular weight version of a corresponding polymer. The strength of interfacial interactions can be controlled by the chain length (molecular weight) of the oligomeric groups. For example, longer chain lengths can provide stronger van der Waals interactions with the polymer matrix.

An oligomer can be a homooligomer, wherein each of the polymerizable units is at least substantially the same, or can be a copolymer including two or more polymerizable units that are not substantially the same, or are substantially different. As used herein, “substantially the same,” or “substantially similar” in reference to polymerizable units refers to polymerizable units that have the same basic chemical structure, but may vary in one or more substituents without significantly affecting the chemical properties of the polymerizable unit. OGN compositions of the present invention can include oligomers that are one or more of the following types of copolymer: random, alternating, periodic, and block. Oligomers suitable for use in the OGN compositions of the invention include linear oligomers or branched oligomers.

While OGN compositions of the invention include at least one or more oligomers attached to the nanoparticle through a coupling group, preferably the amount of oligomers attached to the nanoparticle through a coupling group is sufficient to achieve complete or partial surface coverage of the nanoparticle. The strength of interfacial interactions can depend on the density of oligomeric surface groups surrounding the filler nanoparticle. For example, in a functionalization of a nanoparticle, oligomeric coverage can be described in terms of number of oligomers per area. For example, oligomeric coverage of a nanoparticle can be in a range of from about one oligomer per nm² to about 1 oligomer per 10,000 nm², or more preferably in a range of from about one oligomer per nm² to about one oligomer to about 1,000 nm². For example, in a functionalization of graphene nanoparticle, oligomeric coverage can be in a ratio of about one oligomer per every 100 to 200 surface carbon atoms, about one oligomer per 70 surface carbon atoms, or about one oligomer per every 40 surface carbon atoms. In other embodiments the number density of oligomers to surface carbon atoms can be as low as 1 oligomer per about 10,000 surface carbon atoms to as high as 1 oligomer per about 10 surface carbon atoms. It will be appreciated that the required number density per surface carbon atom or density per surface area to effect coverage of the surface of a nanoparticle generally decreases as the size (e.g., atomic mass) of the oligomer increases. Hence fewer lengthier oligomers can provide similar surface coverage as more, shorter, oligomers. The number of oligomers per surface area of nanoparticle can be measured by any method known to a person of skill in the art, including transmission electron microscopy.

The functionalization density of oligomer coverage of the nanoparticle surface can also be characterized by thermogravimetric analysis (TGA). In some embodiments a mass fraction of organic matter attributable to the surface oligomers (and any organic coupling agent to which they may be attached) is in a range from about 2% to about 90%, and more preferably in a range of from about 5% to about 80% based on total weight of the OGN. It will be appreciated that the mass fraction will depend on the molecular weight of the oligomers, and the higher the molecular weight of the oligomers, the higher the mass fraction of organic matter will be in OGNs. Similarly, it will be appreciated that the mass fraction will depend on the molecular weight to an organic coupling agent to which the oligomer is attached, if the oligomer is attached to the nanoparticle through an organic coupling agent.

OGN compositions can include one or more oligomers derived from two or more polymerizable units where at least one polymerizable unit can be at least substantially similar to at least one of the polymerizable units of the polymer matrix. An OGN composition of the invention that can be used as a filler in a polymer containing a single type of repeating unit, i.e., a homopolymer, can include one or more oligomeric groups that are a low-molecular weight version of the matrix polymer. For example, an OGN composition of the invention for use as a filler in polystyrene can include one or more oligomeric groups that are low-molecular weight polystyrene. For example, an OGN composition of the invention for use as a filler in polyethylene can include one or more oligomeric groups that are low-molecular weight polyethylene. An OGN composition of the invention that can be used as a filler in a polymer containing two or more substantially different polymerizable units, i.e., a copolymer can include one or more oligomers wherein at least one polymerizable unit of the two or more oligomers is at least substantially similar to each of the two or more substantially different polymerizable units of the polymeric matrix. Thus, an OGN composition of the invention that can be used as a filler in a copolymer can include one or more oligomeric groups that are each the low-molecular weight oligomer of each counterpart of the copolymer. That is, each oligomer group can include two or more of substantially the same polymerizable unit, that polymerizable unit can be the same as at least one polymerizable unit of the polymer matrix in which the OGN is intended to be used. For example, an OGN composition of the invention for use as a filler in polyethylene oxide-polystyrene can include one or more oligomeric groups that are low-molecular weight polyethylene oxide and one or more oligomeric groups that are low-molecular weight polystyrene. An OGN composition of the invention that can be used as a filler in a polymer containing a cross-linked network including different polymerizable units can include one or more oligomeric groups that are linear oligomers each composed of similar polymerizable units as the polymer matrix. These examples are illustrative only and are not meant to be limiting.

Suitable polymerizable units that comprise the oligomers can be selected from any type of polymerizable monomer, as well as combinations of monomers such as in a copolymerization or block-copolymerization. Examples of suitable monomers include, but are not limited to, any of the monomers that can be polymerized using free-radical polymerization, condensation polymerization, ring-opening polymerization, and the like. Suitable free-radical monomers include vinyl aromatic monomers (e.g., styrenes), dienes (e.g., butadiene and isoprene), acrylics, methacrylics, nitrogen-containing vinyl compounds such as vinylpyridines, and any combination thereof.

Suitable condensation polymers include, but are not limited to, polyesters (PEs), polyamides (PAs), and polycarbonates (PCs). Suitable polyesters include homo- or copolyesters that are derived from aliphatic, cyclo aliphatic or aromatic dicarboxylic acids and diols or hydroxycarboxylic acids. Non-limiting, exemplary polyesters include poly(ethylene terephthalate) (PET), poly(butylene terephthalate) (PBT), poly(ethylene naphthalate) (PEN), and poly(butylene naphthalate). Suitable polyamides include polyamides produced by polycondensing a dicarboxylic acid with a diamine, polyamides produced by polymerizing a cyclic lactam, and polyamides produced by co-polymerizing a cyclic lactam with a dicarboxylic acid/diamine salt. The polyamides include polyamide elastomer resins. Suitable polyamide elastomer resins include nylon 6, nylon 6-6, nylon 6-10, nylon 11, nylon 12, and co-polymers and blends of any two or more such polyamides. Suitable polycarbonates include, but are not limited to, aromatic polycarbonates produced by reactions of bisphenols with carbonic acid derivatives such as those made from bis-phenol A (2,2-bis(4-hydroxyphenyl)propane) and phosgene or diphenyl carbonate.

In another embodiment suitable oligomers comprise two or more polymerizable units and can improve dispersion, interfacial strength, or both dispersion and interfacial strength between the nanoparticle and the polymer matrix. A person of skill in the art will understand how to measure the dispersion of the OGN in the polymer matrix (and of the nanoparticle in the polymer matrix as a reference point). For example, any one or more of transmission electron microscopy, rheology, small angle X-ray scattering or X-ray diffraction methods can be used to quantify dispersion. For example, in rheology one can measure the gel point, which is the concentration of OGN at which the slope of G′ versus oscillation frequency approaches zero at low frequency, i.e., the percolation concentration of filler particles. As used herein, G′ is the storage modulus of a material determined using dynamic mechanical analysis. For OGNs prepared using graphene sheet nanoparticles or carbon nanotubes, the percolation concentration is typically in the range of from about 0.05% to about 5%, and more typically about 0.5%. Percolation concentration of conductive particles and other high-contrast nanoparticles (i.e., having a high electron density such as metals and atoms having an atomic number greater than about 20) can also be measured using TEM. In TEM, the average number of particles per square micrometer can be counted. In addition, dispersion can be quantified by measuring the average interparticle separation or for plate-like particles direct measurement of thickness and length. Aspect ratio and particle size can also be measured by TEM. A person of skill in the art will also understand how to measure the interfacial strength between the OGN and the polymer matrix (and between the nanoparticle and the polymer matrix as a reference point). Interfacial strength measurements are desirably analyzed separately from improvements in dispersion; for example improvements in interfacial strength can be measured by modulus or impact strength. Modulus or impact strength measurements can be used to infer improvements in interfacial strength. Methods for quantifying the dispersion and interfacial strength of a nanoparticle in a composite material have been described in Kim H, Macosko C M, “Processing-Property Relationships of Polycarbonate/Graphene Composites,” Polymer (2009) and Kim H, Macosko C M, “Morphology and Properties of Polyester/Exfoliated Graphite Nanocomposites,” Macromolecules (2008), the entire contents of which are incorporated herein by reference.

The OGNs are desirably discrete or unagglomerated and dispersible, miscible or otherwise compatible (preferably substantially compatible) with/in the polymeric matrix, and precursors thereto. In some embodiments, the selection of suitable oligomers for providing compatible OGNs for a particular polymeric matrix can be made by matching the solubility parameters of the oligomers to the solubility parameters of the polymeric matrix. Schemes for estimating how well matched the solubility parameters are, include the Van Krevelen parameters of delta d, delta p, delta h and delta v. See, for example, Van Krevelen et al., Properties of Polymers. Their Estimation and Correlation with Chemical Structure, Elsevier Scientific Publishing Co., 1976; Olabisi et al., Polymer-Polymer Miscibility, Academic Press, NY, 1979; Coleman et al., and Specific Interactions and the Miscibility of Polymer Blends, Technomic, 1991. Delta d is a measure of the dispersive interaction of the material, delta p is a measure of the polar interaction of the material, delta h is a hydrogen bonding parameter of the material and delta v is a measurement of both dispersive and polar interaction of the material. Such solubility parameters may either be calculated, such as by the group contribution method, or determined by measuring the cloud point of the material in a mixed solvent system consisting of a soluble solvent and an insoluble solvent. The solubility parameter at the cloud point is defined as the weighted percentage of the solvents. Typically, a number of cloud points are measured for the material and the central area defined by such cloud points is defined as the area of solubility parameters of the material.

In certain embodiments of the present invention, the solubility parameters of the OGNs and that of the composite can be substantially similar. In this case, compatibility between the OGN and the composite may be improved, and phase separation and/or aggregation of the OGN are less likely to occur.

The OGNs may be dispersed in a polymerization solvent used to prepare composite, or they may be isolated by, for example, vacuum evaporation, by precipitation into a non-solvent, and spray drying; the isolated OGNs may be subsequently redispersed within a material appropriate for incorporation into a polymeric matrix to give rise to a composite.

The OGN compositions described herein can be in the form of a particle-dispersion in a fluid. Such a fluid can be an organic liquid or an aqueous liquid. OGNs prepared in a suitable aqueous or non-aqueous fluid can be subsequently dried to a powder form, such as by spray-drying or lyophilization. Hence, the OGN compositions described herein can also be provided as a powder.

Suitable OGN compositions can be used as filler in a polymeric matrix. As filler in a polymeric matrix, OGN compositions of the invention can impart any of a number of properties to the resulting composite. For example, OGN compositions of the invention can impart greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or fire retardance, increased electrical conductivity, increased thermal conductivity, increased radio wave deflection, or any combination or subcombination thereof, to the polymer matrix when the oligomer-grafted nanofiller is disposed in the polymer matrix compared to the polymer matrix free of the oligomer-grafted nanofiller. OGN compositions of the invention can be used in the manner and to impart any and all of the properties for which prior art fillers or modifiers have been used.

Methods of making OGN can include reacting a nanoparticle with one or more coupling agents to form a nanoparticle that is attached to one or more coupling agents. Alternatively, functionalized nanoparticles, or nanoparticles attached to one or more coupling agents, can be used as a starting material. Nanoparticles or nanoparticles that are attached to one or more coupling agents can be dispersed in a fluid. The fluid can be aqueous or non-aqueous.

An OGN of the invention can be made by grafting a nanoparticle with one or more oligomers to form the OGN. Methods include reacting relative amounts of oligomer, contacting groups, and nanoparticles sufficient to achieve complete or partial coverage of the surface of the nanoparticle with oligomer. In particular, an amount of coupling group can be reacted with an amount of nanoparticle that will provide oligomer with sufficient attachment points to partially or completely cover the surface of the nanoparticle. The amount of coupling groups, the efficiency of coupling, steric considerations, can affect the degree of surface coverage by oligomer, among other factors. In a non-limiting example, in a functionalization of graphene nanoparticle, an amount of coupling group can be reacted with an amount of nanoparticle that will provide sufficient attachment points to achieve oligomeric coverage of the nanoparticle in a ratio of about one oligomer per every 100 surface carbon atoms, about one oligomer per 70 surface carbon atoms, or about one oligomer per every 40 surface carbon atoms.

Oligomers can be preformed or made separately and then attached to the nanoparticle. Preferably, oligomers that are preformed can be attached to the nanoparticle by being attached to one or more coupling groups or anchoring groups on the nanoparticle. While —OH, —COOH, —NH₂, —C═C, —NCO, epoxide are preferred coupling groups for attaching oligomers, any reactive moiety that can both be attached to a nanoparticle and serve to attach an oligomer can be used in accordance with the invention. Methods for attaching preformed oligomers to coupling groups include, but are not limited to, condensation reactions such as esterification and amidation, and addition reactions, such as free radical addition, atomic transfer radical polymerization reactions, and reversible addition-fragmentation chain transfer reaction.

Alternatively, oligomers can be grown directly on coupling groups that are attached to the nanoparticle. Example coupling agents that can be used to directly grow oligomers include, but are not limited to, organic silanes, di-isocyanates, di-amines, and, for use with clay nanoparticles, and quaternary ammonium.

Once the oligomer has been linked or bonded to the nanoparticle some or all of the fluid can be removed from the OGNs. Keeping the OGNs in at least some fluid can prevent aggregation of the OGN particles.

In another embodiment of the invention, a composite material includes a polymer matrix and one or more OGNs dispersed within the polymer matrix. The one or more OGNs have been described above. Composite materials of the invention can have greater stiffness, toughness, dimensional stability, thermal stability, enhanced electrical conductivity, enhanced thermal conductivity, greater barrier properties, strength, modulus, Tg, chemical corrosion resistance, UV degradation resistance, abrasion resistance, fire resistance or retardance, increased electrical conductivity, increased thermal conductivity, increased radio wave deflection, or any combination or subcombination thereof, as compared to a composite material that is a polymer matrix including nanoparticles that do not have oligomers grafted thereto. Thus, the OGNs can impart desired properties to the polymer matrix or resulting composite material.

While composite materials of the invention can have any amount of OGN sufficient to impart a desired property to the composite material, preferably composite materials of the invention can have a weight percent of the OGN based on the total weight of the composite in the range of from about 0.005% to about 20%, or more preferably in the range of from about 0.01% to about 0.5%, or even more preferably, in the range of from about 0.001% to about 1%.

In compositions of the invention, one or more OGNs can be attached or bonded to the host polymer matrix. OGNs can be covalently bonded to the polymer matrix or ionically bonded to the polymer matrix. OGNs can be attached to the polymer matrix through van der Waals forces. The OGNs can be attached to the polymer matrix by way of covalent or ionic bonding of one or more oligomers of the one or more OGN to the polymer matrix or by van der Waals interactions between one or more oligomers of the one or more OGN and the polymer matrix.

The present invention also includes methods for making a composite material that includes one or more OGNs dispersed in a host polymer matrix. A method for making an OGN-polymer composite can include dispersing an OGN in a polymer matrix that includes one or more polymerizable units and effectuating bonding between the oligomers and the polymer matrix. Any OGN of the invention can be used in methods for making a composite material, such as OGN including oligomers that can improve dispersion, interfacial strength, or both dispersion and interfacial strength between the nanoparticle and the polymer matrix, or oligomers that are derived from two or more polymerizable units where at least one polymerizable unit can be at least substantially similar to at least one of the polymerizable units of the polymer matrix. Dispersing techniques include, but are not limited to, solvent blending and melt compounding. Methods of making an OGN-polymer composite can further include the step of effectuating bonding between the oligomers and the polymer matrix.

Suitable composite materials can also be made by dispersing OGNs in a plurality of monomers and subsequently carrying out a chemical reaction to polymerize the monomers. The OGNs can be applied to the host polymer by direct mixing in the monomer for the target polymer matrix. Alternatively, they can be applied through a master-batch approach, in which OGNs are dispersed at a high concentration in the monomer and the target formulation can then be achieved by diluting the master-batch with monomer. The monomers can be dispersed in a fluid, such as an aqueous or non-aqueous fluid. The chemical reaction appropriate for polymerizing the monomers after addition of the OGNs will depend on the nature of the monomers, but can be, for example, thermally initiated or photo-initiated. In some methods of the invention, the polymerizing step can give rise to at least one covalent bond between the oligomer portion of the oligomer-grafted nanofiller and the polymerized monomer.

Once the OGNs are incorporated in the polymer matrix, the interface between OGN and polymer becomes indistinguishable from the bulk phase and the overall nanocomposite will consist of highly dispersed nanofiller particles in a single phase.

In another embodiment of the invention, an article or workpiece can be made from a composite material of OGN and polymer.

### EXAMPLES

The following examples, while illustrative individual embodiments, are not intended to limit the scope of the described invention, and the reader should not interpret them in this way.

### Example 1

### Functionalization of Graphene Oxide Nanoparticle with Polybutadiene-Polyacrylonitrile Rubber Oligomer

The example is to attach a polybutadiene-polyacrylonitrile rubber oligomer on graphene oxide with a coupling agent. To functionalize graphene oxide (GO) with rubber oligomer, 0.2 g of GO was dispersed in 50 mL dimethyl formamide (DMF) by sonication, then 2 g of methylene diphenyl diisocyanate (MDI) was added. The mixture was stirred at room temperature for one day, and was then coagulated by methylene chloride. After being washed with methylene chloride at least five times by centrifugation, the isocyanate-functionalized GO was then redispersed in 100 mL of DMF. An amount of 4 g of amine-terminated polybutadiene-polyacrylonitrile (ATBN 1300×42, molecular weight 900 g/mol, 18% polyacrylonitrile), was added and the mixture was stirred at 50° C. for 12 h. ATBN-functionalized GO was separated by centrifugation and washed by with acetone for at least 5 times. The product was dispersed in t-butanol and the dispersion was subjected to freeze drying for at least 15 h at room temperature and then 3 h at 60° C. The product was obtained as a fluffy powder.

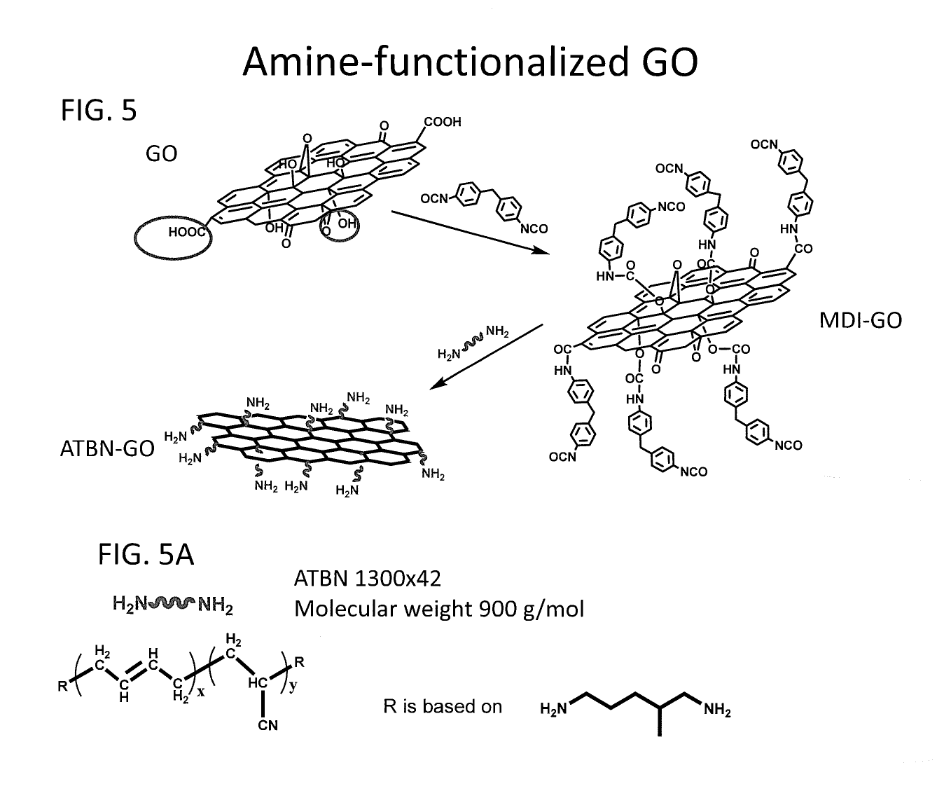

Referring now to FIG. 5, a schematic of the functionalization of graphene oxide (GO) is illustrated. At the top left, graphene oxide is provided with hydroxyl and carboxyl functionalities circled. Methylene diphenyl diisocyanate (MDI) is added to the GO to produce isocyanate-functionalized GO (MDI-GO) Amine-terminated polybutadiene-polyacrylonitrile (ATBN) is added to the MDI-GO to form ATBN-GO. FIG. 5A shows the structure of ATBN.

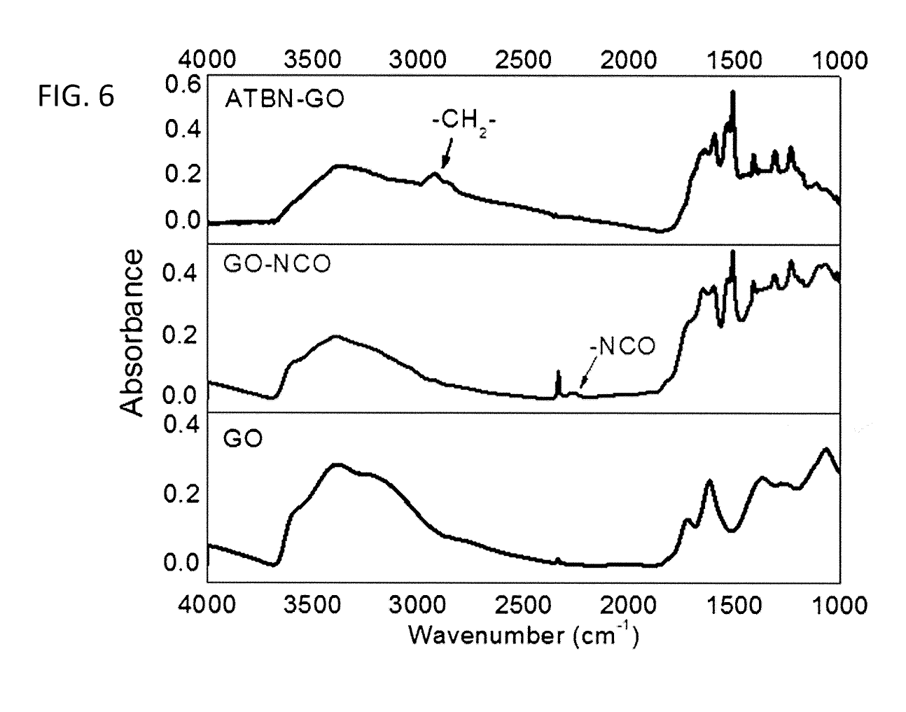

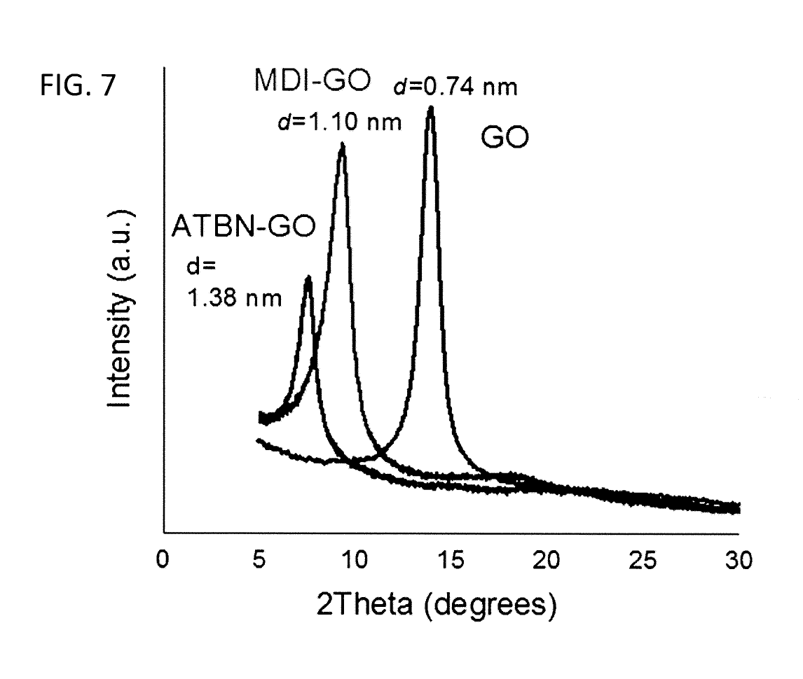

Structural characterization is shown in FIGS. 6 and 7. FIG. 6 shows the FT-IR spectra of ATBN-GO, GO-NCO, compared with the FT-IR spectrum of GO. The peak corresponding to —CH₂— is pointed out on the ATBN-GO spectrum and the peak corresponding to —NCO is pointed out on the GO-NCO spectrum. FIG. 7 shows the x-ray diffraction spectra of ATBN-GO, MDI-GO, and GO.

The functionalization density of ATBN on GO was estimated by thermogravimetric analysis (TGA) and is shown in Table 1. In calculating the functionalization density per 100 carbon atoms, the following assumptions were made: 1) only carbon was left after 800° C. and 2) the structure of the functional group is:

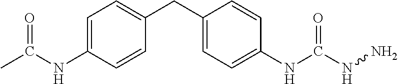 [SMILES: CC(=O)Nc1ccc(Cc2ccc(NC(=O)NN)cc2)cc1]

TABLE 1

| | Weight Loss | Functionalization Density/ |
|---|---|---|
| Sample | (250° C.-800° C.)/wt % | per 100 carbon atoms |
| GO | 17.9 | NA |
| ATBN-GO | 37.3 | 0.39 |

### Example 2

### Preparation of a Composite Material Using the OGNs of Example 1

The desired amount of ATBN-functionalized GO is dispersed in THF by ultra-sonication, then the dispersion is added to a THF solution of polybutadiene-polyacrylonitrile copolymer to achieve a final composite with 0.005 wt % to 20 wt % of modified graphene oxide. After solvent evaporation or precipitation in a non-solvent, such as methanol, the composite is obtained.

### Example 3

### Functionalization of Graphene Nanoparticle with Styrene Oligomer

To grow oligomeric styrene on graphene, silylation of graphene is achieved by stirring graphene oxide and 3-chloropropyl trimethoxy silane in ethanol at 60° C. for 12 h. Then the chlorine-functionalized graphene is dispersed in DMF with CuCl and styrene for atom transfer radical polymerization (ATRP) reaction.

### Example 4

### Functionalization of Graphene Nanoparticle with Polyester Oligomer

To grow oligomeric polyester on graphene, a similar approach as to diamine functionalization of graphene oxide is used; a substitution of diamine to hydroxyl-terminated polyester oligomer produces polyester-functionalized GO.

### Example 5

### Functionalization of Graphene Nanoparticle with Ethylene Oxide Oligomer

To grow oligomeric polyester on graphene, a similar approach as to diamine functionalization of graphene oxide is used; a substitution of diamine with polyethylene glycol (PEG) or polyethylene oxide (PEO) produces PEG/PEO-functionalized GO.

### Example 6

### Functionalization of Graphene Nanoparticle with Acrylic or Methacrylate Oligomer

To grow oligomeric acrylic or methacrylate on graphene, a similar approach as to polystyrene functionalization of graphene oxide is used; a substitution of styrene to acrylic/methacrylate monomers produces acrylic/methacrylate oligomer-functionalized GO.

### Example 7

### Functionalization of Graphene Nanoparticle with Vinyl Ester Oligomer

To grow oligomeric vinyl ester on graphene, a similar approach as to polystyrene functionalization of graphene oxide is used; a substitution of styrene to vinyl ester will produce vinyl ester functionalized GO.

### Example 8

### Functionalization of Graphene Nanoparticle with Epoxy Oligomer

To grow oligomeric epoxy on graphene, diamine-functionalized GO is used and a further reaction with epoxy resin grafts epoxy monomer on GO.

### Example 9

### Functionalization of Graphene Nanoparticle with Aramid Oligomer

To grow oligomeric aramid on graphene, a similar approach as to diamine functionalization of graphene oxide is used; a substitution of diamine with amine-terminated aramid oligomer produces aramid-functionalized GO.

### Example 10

### Functionalization of Carbon Nanotube with Oligomer

Carbon nanotubes (CNT) are treated in concentrated nitric acid to produce hydroxyl groups and carboxyl groups on CNT.

Alternatively, carbon nanotubes (CNT) are treated in a mixture of phenylene diamine/4-hydroxylethyl aniline and isoamyl nitrite in organic solvent to produce amino/hydroxyl groups on CNT.

After generating hydroxyl or amino groups on the carbon nanotube surface, oligomer can be grafted to the carbon nanotube surface using a similar approach as for graphene oxide in the above methods.

### Example 11

### Functionalization of Carbon Nanofiber with Oligomer

Carbon nanofibers are treated in a similar approach as carbon nanotubes of Example 10.

### Example 12

### Functionalization of Graphene Sheet with Oligomer

Graphene sheets are treated in a similar approach as carbon nanotubes of Example 10.

### Example 13

### Functionalization of Graphite Nanoparticle with Oligomer

Graphene nanoparticles are converted to graphene oxide after treatment in a mixture of concentrated sulfuric acid and potassium permanganate (the Hummers' method). The graphene oxide particles are then functionalized in accordance with Examples 1-9.

### Example 14

### Functionalization of Silica Nanoparticle with Oligomer

Silica nanoparticles are treated with 3-aminopropyl trimethoxysilane in ethanol to generate amino groups on the silica nanoparticle surface. After generating amino groups on the silica nanoparticle surface, oligomer can be grafted to the silica nanoparticle surface using a similar approach as for graphene oxide in the above methods.

### Example 15

### Functionalization of Metal Oxide Nanoparticle with Oligomer

Metal oxide nanoparticles are treated using a similar approach as for silica nanoparticles in the Example 14.

### Example 16

### Functionalization of Layered Silicates Nanoparticle with Oligomer

Refluxing the layered silicate nanoparticles with a solution of alkylammonium halide exchanges the interlayer metal cations to alkylammonium cation. Using octadecyl bis(2-hydroxylethyl)methyl ammonium chloride, hydroxyl group is generated on the surface of the layered silicates nanoparticle. After generating hydroxyl groups on the layered silicates surface, oligomer can be grafted to the layered silicates nanoparticle surface using a similar approach as for graphene oxide in the above methods.

### Example 17

### Functionalization of Clay Nanoparticle with Oligomer

Clay nanoparticles are treated using a similar approach as for layered silicates in Example 16.

Alternatively, oligomer can be grafted to a commercial organoclay, such as Cloisite 30B, which has two hydroxyl groups on each organic modifier, using a similar approach as for graphene oxide in the above methods.

### Example 18

### Functionalization of Layered Chalcogenide Nanoparticle with Oligomer

Terpyridine derivatives are used to chelate the surface metal atoms on chalcogenide particles. Hydroxyl groups are generated if the terpyridine derivative contains terminal hydroxyl groups. After generating hydroxyl groups on the chalcogenide particle surface, oligomer can be grafted to the chalcogenide particle surface using a similar approach as for graphene oxide in the above methods.

### Example 19

### Functionalization of Ceramic Nanoparticle with Oligomer

Ceramic nanoparticles are treated in nitric acid to activate surface hydroxyl groups. After generating hydroxyl groups on the ceramic nanoparticle surface, oligomer can be grafted to the ceramic nanoparticle surface using a similar approach as for graphene oxide in the above methods.

### Example 20

### Functionalization of Metal Nanoparticles with Oligomer

Metal nanoparticles are treated with long-chain thiols (e.g., C-12, C-16, or C-18 thiol) containing a reactive group on the opposite end to attach oligomers.

### Example 21

### Functionalization and Characterization of Graphene Oxide Nanoparticle with Polybutadiene-Polyacrylonitrile Rubber Oligomer

ATBN chains (Hycar 1300×42 primary amine-terminated poly(butadiene-acrylonitrile) (MW=900 g mol−1, Emerald Performance Materials), dried under vacuum before functionalization of graphene oxide) were grafted onto GO by using MDI (4,4′-methylene diphenyl diisocyanate (98%, Sigma-Aldrich)) as the coupling agent, as illustrated in FIG. 5.

Graphene oxide (GO) was synthesized from natural graphite according to the Hummers method. 115 mL concentrated H₂SO₄ was added to a 1 L beaker which was then placed in an ice bath. A mass of 2.5 g NaNO₃ was added and dissolved, followed by the addition of 5 g of graphite flakes (natural graphite flakes, SP-1, 45 micrometer, Bay Carbon) while stirring. An amount of 15 g KMnO₄ was then added slowly. After the ice bath was removed, the temperature of the mixture increased slowly, but it was controlled to maintain a temperature between 35° C. and 40° C. The reaction proceeded for 1 h, and a dark slurry was formed. A volume of 230 mL of deionized (DI) water was then added to dilute the mixture, and the temperature increased quickly to above 80° C. (Caution: strong exotherm). After 15 min, the mixture was further diluted with 700 mL DI water in 1 L beaker, and then H₂O₂ solution (30 wt %) was slowly added to stop the oxidation until the color turned to bright brown or yellow brown. The resulting slurry was centrifuged and washed with 2 M HCl until it was SO₄²⁻ free. Then the brown dispersion was dialyzed several times in deionized water until the pH reached a value of ˜3 and remained unchanged. The pH of the GO dispersion was adjusted to around 6 with ammonia, and then bath sonication was used to aid the exfoliation of GO. GO was obtained as a powder by freeze-drying the dialyzed solution and further drying in a vacuum oven at 60° C. overnight.

First, 200 mg of GO were dispersed in 50 mL of DMF (dimethylformamide, dried with molecular sieves before use) by bath sonication. The dispersion was purged with nitrogen for 30 min, followed by addition of 4 g of MDI. The reaction was carried out in an oil bath at 60° C. for 24 h, and then the mixture was flocculated by adding dichloromethane (dried with molecular sieves before use). The solid product was washed with dichloromethane at least five times to remove any excess MDI. The centrifuge tubes were sealed with parafilm to minimize exposure to moisture from the air. The resulting MDI-GO (also referred to as “GO-NCO” herein) was dispersed in 100 mL of DMF without drying. After bath sonication, 20 g of 10 wt % ATBN in DMF was added while stirring. The reaction was carried out at 60° C. with nitrogen purging for two days. Acetone was used to flocculate the mixture, and the solid product was collected by centrifugation. After washing with acetone at least five times, ATBN-GO (also referred to as “GA” herein) was redispersed in tert-butanol to make a dispersion for freeze-drying. GA was obtained as a powder after freeze-drying the tert-butanol dispersion and further drying in a vacuum over at 60° C. for 6 h.

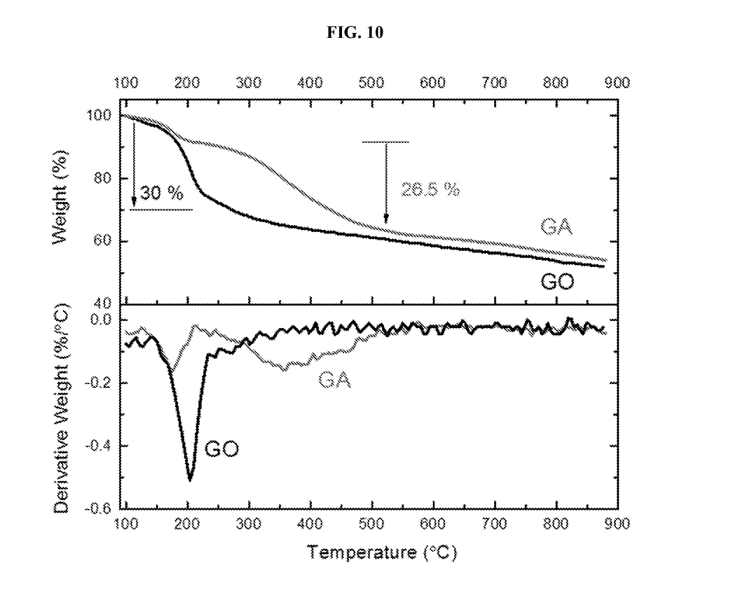

FIG. 10 shows the TGA and first derivative TGA curves of GO and GA from room temperature to 900° C. in nitrogen. Thermogravimetric analysis (TGA) was used to determine the content of organic functional groups on GA. TGA were carried out with a Netzsch STA 409 PC instrument in flowing nitrogen using a ramping rate of 10° C. min⁻¹. As shown in FIG. 10, GO displays a major weight loss of 30% from 150° C. to 250° C., which is due to the decomposition of labile surface hydroxyl groups. As for GA, two weight loss processes were observed from the derivative TGA curve. The first weight loss with a derivative TGA peak at 175° C. was assigned to the loss of surface hydroxyl groups, similar to the one in GO. The second weight loss with a broad peak in the derivative TGA curve at 370° C. was assigned to the loss of covalently bonded organic functional groups. The organic content of GA was calculated to be 26.5 wt % from the second weight loss of GA.

### Example 22

### Synthesis and Characterization of Epoxy/Graphene Nanocomposites

Four epoxy nanocomposites were synthesized and characterized: two epoxy nanocomposites with nanofiller comprising two grades of pristine graphene nanosheets (referred to herein as “GS1” and “GS2”, supplier and specifications are noted below), one epoxy nanocomposite with nanofiller comprising graphene oxide (GO) (synthesized from natural graphite according to the Hummers method as described in Example 21), and one epoxy nanocomposite with nanofiller comprising ATBN-GO (GA) synthesized as described in Example 21.

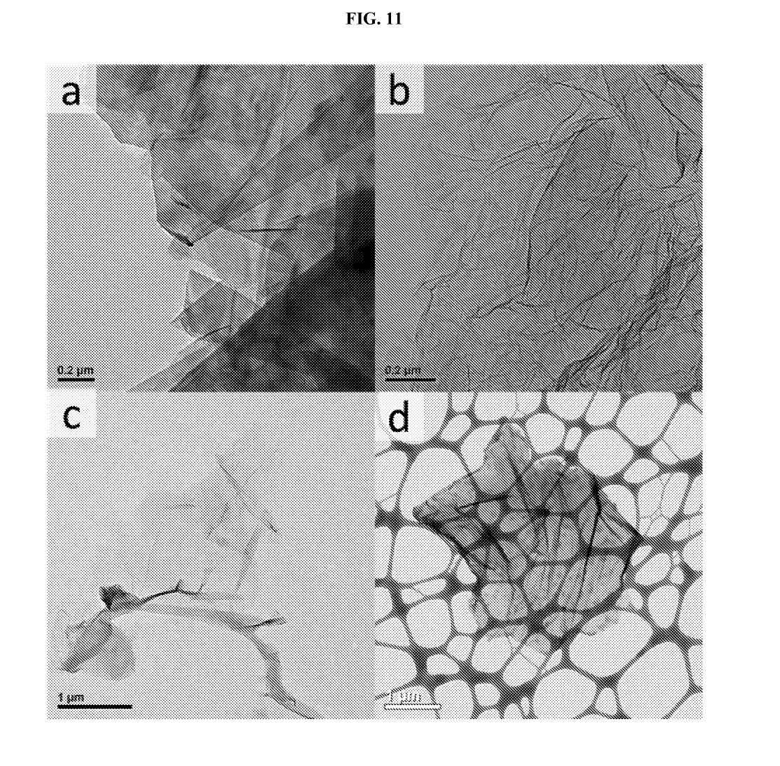

The morphology of the nanofillers was characterized by electron microscopy. In transmission electron microscopy (TEM) images in FIG. 11, all the graphene materials were observed as thin nanosheets with sizes of several micrometers. The wrinkled morphology of GS2, GO, and GA is due to the flexibility of the 2D nanosheets. However, fewer wrinkles were observed for GS1 in FIG. 11(a), because the stacking of many graphene layers in GS1 makes it graphite-like and thus more rigid than individual nanosheets. The small dots in the TEM image of GA were likely the result of uneven surface functionalization with ATBN molecules. Transmission electron microscopy images were obtained on a FEI Tecnai T12 microscope using an accelerating voltage of 100 kV. Graphene samples were picked up on carbon-coated Cu grids from dispersions. Polymer samples were first microtomed (Leica Ultracut) at room temperature into 70 nm thick sections before being picked up on Cu grids.

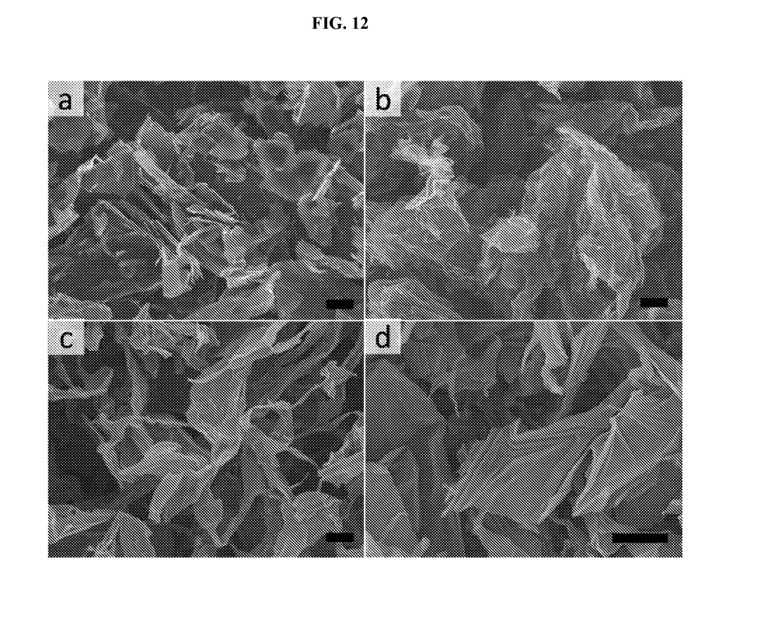

Bulk morphologies of the obtained graphene powders were revealed by scanning electron microscopy (SEM). Scanning electron microscopy images were taken using a JEOL 6500 FEG-SEM with an accelerating voltage of 5 kV. Samples were mounted on A1 stubs, and a 5 nm Pt coating was applied on insulating samples. The pristine graphene samples, GS1 and GS2, were received as fluffy powders. In FIG. 12, GS1 appeared to have a flake-like morphology similar to the TEM observation (FIG. 11(a)), whereas the thin graphene sheets of GS2 have a ball-like morphology due to their high flexibility. As for GO, it is difficult to obtain these powders in bulk form by filtering the GO dispersion, because GO nanosheets block the pores of the membrane filter. Also, by filtration, GO was obtained as a stacked and dense paper, which would be hard to disperse in the amine curing agent. Freeze-drying is a simple and scalable method to separate nanoparticles from their dispersions, which keeps them from aggregation. The SEM images of GO and GA after freeze-drying are shown in FIGS. 12(c) and 12(d), respectively. It can be clearly seen that the nanosheets still maintain high aspect ratios, and there is no substantial stacking of the sheets.

To synthesize the graphene nanosheet composites, the desired amount of graphene nanosheets (Angstron Materials: GS1 (N006-P, 10-20 nm thickness, ˜14 μm size, 1.5% oxygen content, surface area ≦21 m²g⁻¹; GS2 (N002-PDR, <1 nm thickness, ≦10 μm size, 2.1% oxygen content, 400-800 m²g⁻¹ surface area) dried under vacuum at 70° C. overnight before use) was first weighed and dispersed in Jeffamine D230 curing agent (MW=250 g mol⁻¹, Huntsman) using an ultrasonic probe sonicator for 3 h at 90° C. The resulting blends were denoted as D_GS1_x and D_GS2_x, where x is the graphene weight percentage in the dispersion. After the D230-graphene dispersion had cooled down to room temperature, it was added to EPON™ Resin 828 liquid epoxy resin (MW˜377 g mol⁻¹ from Momentive), and the mixture was mechanically stirred with a Cowles blade at 700 rpm for 2 min and then 300 rpm for 15 min. The amounts of epoxy resin and amine curing agent were 100 and 35 parts by weight, respectively. Next, the mixture was degassed for 15 min in a vacuum oven, followed by pouring into glass molds. The nanocomposites were obtained after curing at 60° C. for 2 h and 120° C. for another 12 h. The final nanocomposites were denoted as E_GS1_y and E_GS2_y, where y is the graphene weight percentage in the nanocomposite.

To synthesize the GO nanocomposites, the desired amount of GO (synthesized from natural graphite according to the Hummers method as described in Example 21) was first weighed and dispersed in Jeffamine D230 curing agent (MW=250 g mol−1, Huntsman) using an ultrasonic probe sonicator for 3 h at 70° C. The resulting blends were denoted as D_GO_x, where x is the graphene weight percentage in the dispersion. After the D230-graphene dispersion had cooled down to room temperature, it was added to EPON™ 828 epoxy resin (MW˜377 g mol−1, Momentive), and the mixture was mechanically stirred with a Cowles blade at 700 rpm for 2 min and then 300 rpm for 15 min. The amounts of epoxy resin and amine curing agent were 100 and 35 parts by weight, respectively. Next, the mixture was degassed for 15 min in a vacuum oven, followed by pouring into glass molds. The nanocomposites were obtained after curing at 60° C. for 2 h and 120° C. for another 12 h. The final nanocomposites were denoted as E_GO_y, where y is the graphene weight percentage in the nanocomposites.

To synthesize the ATBN-GO (also referred to as “GA”) nanocomposites, the desired amount of ATBN-GO was first weighed and dispersed in Jeffamine D230 curing agent (MW=250 g mol−1, Huntsman) using an ultrasonic probe sonicator for 3 h at 70° C. The resulting blends were denoted as D_GA_x, where x is the graphene weight percentage in the dispersion. After the D230-graphene dispersion had cooled down to room temperature, it was added to EPON™ 828 epoxy resin (MW˜377 g mol−1, Momentive), and the mixture was mechanically stirred with a Cowles blade at 700 rpm for 2 min and then 300 rpm for 15 min. The amounts of epoxy resin and amine curing agent were 100 and 35 parts by weight, respectively. Next, the mixture was degassed for 15 min in a vacuum oven, followed by pouring into glass molds. The nanocomposites were obtained after curing at 60° C. for 2 h and 120° C. for another 12 h. The final nanocomposites were denoted as E_GA_y, where y is the graphene weight percentage in the nanocomposite.

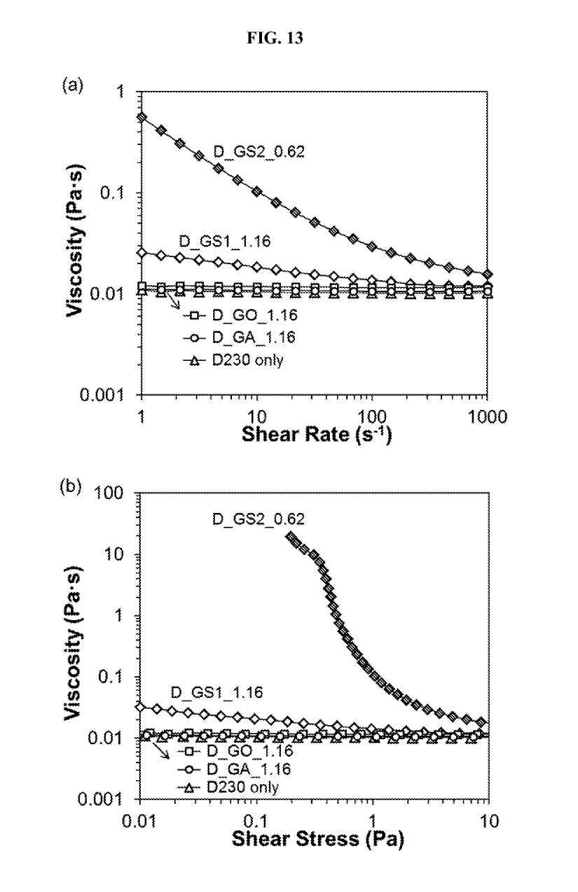

Jeffamine D230 curing agent is much less viscous than the epoxy resin. The graphene nanofillers were first dispersed in the D230 by ultrasonication. All D_graphene dispersions were pourable at room temperature and they had fluid-like behavior with very low viscosity as shown in FIG. 13. Rheological characteristics of the curing agent/graphene blends were measured using a AR-G2 (TA Instruments) rotational rheometer with a 40 mm cone plate at room temperature. Viscosity profiles were obtained under steady state flow as the shear rate was increased in logarithmic increments from 0.1 to 1000 s⁻¹. FIGS. 13(a) and 13(b) show the viscosity of D230 and graphene dispersions via mixing and ultrasonication as a function of shear rate and shear stress, respectively. With GS1 and GS2, the dispersions showed shear thinning, whereas Newtonian behavior was observed for neat D230 and the dispersions with GO and GA. Shear thinning came from swelling of graphene by the D230 and form a 3-dimensional network of graphene nanosheets within the D230 matrix. The viscosity dramatically increased by the thinner, fewer-layered graphene nanosheet, GS2, which showed stronger shear thinning than GS1. On the other hand, D230 with GO or GA showed only a small increase in viscosity, indicating that these nanofillers were not exfoliated but remained in thick layered stacks.

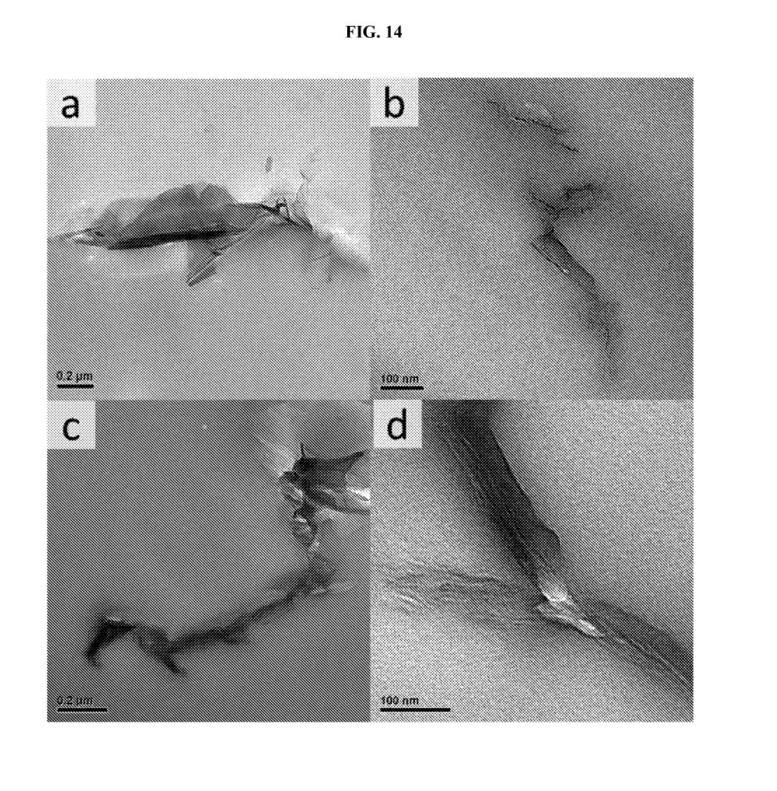

Although not limited to any particular theory, it is believed that the dispersion state of graphene nanofillers in the final epoxy polymer is greatly affected by the compatibility between epoxy/amine and the surface of different graphene materials. The TEM images in FIG. 14 illustrate the state of dispersion of nanofiller particles in the epoxy matrix. Transmission electron microscopy images were obtained on a FEI Tecnai T12 microscope using an accelerating voltage of 100 kV. Graphene samples were picked up on carbon-coated Cu grids from dispersions. Polymer samples were first microtomed (Leica Ultracut) at room temperature into 70 nm thick sections before being picked up on Cu grids. Good dispersions of high-aspect-ratio graphene nanosheets can be observed for E_GS1 (FIG. 14(a)) and E_GS2 (FIG. 14(b)). The thickness values of the nanosheets were ca. 15 nm and 3 nm for GS1 and GS2 in TEM, respectively. Similar to the TEM images of pristine graphenes (FIG. 12), GS1 displays less corrugation than GS2 due to the high rigidity of the multilayered nanosheets. Despite the good dispersity of GO in water, the dense stacking of GO nanosheets is clearly seen in E_GO even after intense ultrasonication treatment (FIG. 14(c)). Although not limited to any particular theory, it is believed that the aggregation of GO nanosheets resulted from the unmatched surface properties between hydrophilic GO and the D230/epoxy matrix. After modification with ATBN, intercalation and exfoliation of GA was observed in E_GA (FIG. 14(d)). The thicknesses of GO and GA aggregates in the nanocomposites are ca. 30 nm and 6 nm, respectively, estimated from TEM.

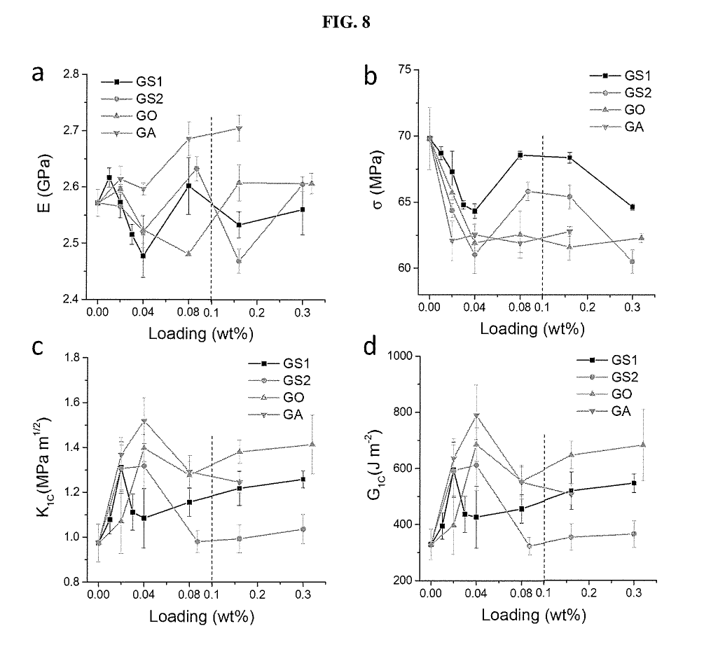

Flexural modulus and strength of the epoxy/graphene nanocomposites are shown in FIG. 8, which shows (a) modulus, (b) tensile strength, (c) fracture toughness, and (d) fracture energy plots of the epoxy nanocomposites. To manifest the effect at small loadings, the increment is 0.04 for x<0.1 and 0.1 for x>0.1. The scale change in the x-axis is indicated by the dashed line. More detailed data is provided in Table 3. Measurement and calculation methods are described in more detail below. The moduli of epoxy nanocomposites with pristine graphenes fluctuate as a function of graphene contents from 0.01 to 0.3 wt %. The insignificant effect of pristine graphenes on modulus change is due to the weak epoxy-graphene interface, although not limited to any particular theory, it is believed to be resulting from the inert graphene lattice on the surface of GS1 and GS2. E_GO also displayed negligible change in modulus compared to the neat epoxy; although not limited to any particular theory, it is believed to be attributed to the aggregation of GO nanosheets in the epoxy matrix. A slight increase in modulus was observed for E_GA and, although not limited to any particular theory, it is believed to be attributed to the good dispersion of GA nanosheets as well as the covalently bonded GA/epoxy interface. Graphene nanofillers have a more significant impact on the fracture toughness and fracture energy of the epoxy matrix, as shown in FIGS. 8(c) and 8(d). Crack-opening tests on compact tension samples were performed to measure the mode-I critical stress intensity factor (K_{Ic}, fracture toughness) and critical strain energy release rate (G_{Ic}, fracture energy) of the pure epoxy matrix and E_GO and E_GA nanocomposites at various weight fractions of graphenes. The K_{Ic} of the neat epoxy, 0.97 MPa m^{1/2}, was in good agreement with other neat epoxy polymers in previous studies. For E_GS1, the K_{Ic} increased by 35% with only 0.02 wt % of graphene loading, compared to the base value of the epoxy. A sharp decrease of K_{Ic} was observed at 0.04 wt % of graphene loading, which was followed by a trend of slow increase upon higher graphene loadings. Peak behavior in the toughening effect can be seen in FIG. 8(c) for the composites with other graphene nanofillers at 0.02 wt % or 0.04 wt % graphene loading, and the maximum improvements of K_{Ic} were 32%, 40% and 52% for E_GS2, E_GO and E_GA, respectively. The best performance of E_GA, although not limited to a particular theory, is believed to be a result of the good dispersion of GA and the strong epoxy-GA interface in the nanocomposites. Correspondingly, E_GA displayed a maximum 2.4 times improvement in G_{Ic} at 0.04 wt % of graphene loading.

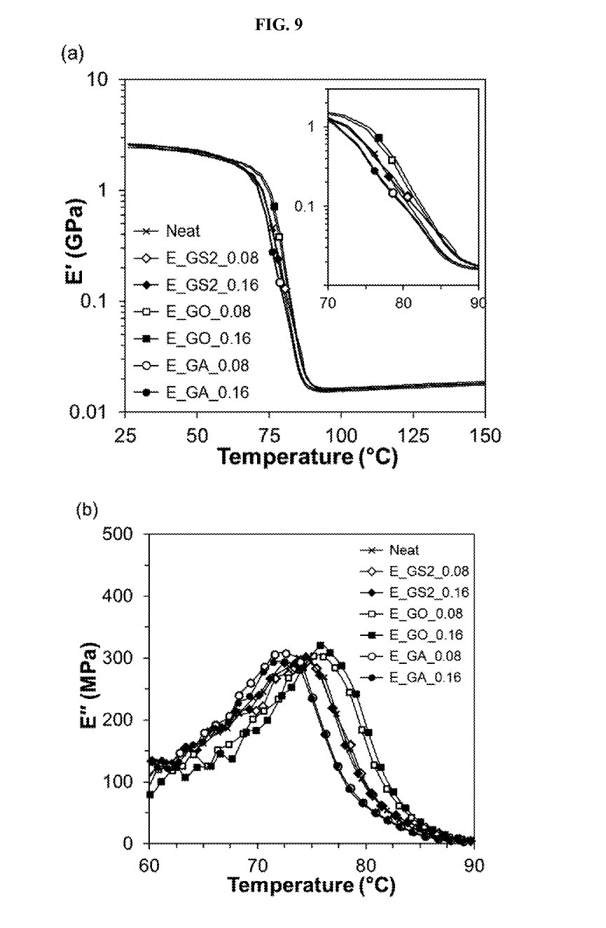

FIG. 9 shows the dynamic mechanical analysis of the neat epoxy and epoxy/graphene nanocomposites, including (a) storage modulus E′, and (b) loss modulus, E″. Thermo-mechanical properties of E_graphene composites were studied by dynamic mechanical analysis (DMA). The addition of 0.08 and 0.16 wt % of graphene to epoxy induced no significant increase (less than 5%) in tensile storage modulus, E′, as shown in FIG. 9(a). As shown in FIG. 9(b), E_GS1 and E_GS2 exhibited maximum E″ at the same temperature as neat epoxy, whereas E_GO had it at higher temperature due to the strong epoxy-GO interfaces. As for E_GA, it displayed maximum E″ at the lowest temperature among all nanocomposites, which could have resulted from the addition of grafted rubber chains on graphene surfaces.

TABLE 2

| | | DMA | | | | |
|---|---|---|---|---|---|---|
| | | | | T_{g} by | | |
| | Filler | E′ at | E′ at | max | | DSC |
| | content | 30° C. | 100° C. | E″ | T_{g} by max tan δ | T_{g} |
| Sample | (wt %) | (GPa) | (MPa) | (° C.) | (° C.) | (° C.) |
| E_Neat | 0 | 2.47 | 15.8 | 73.8 | 83.1 | 70.6 |
| E_GS2 | 0.08 | 2.53 | 16.2 | 74.6 | 84.2 | 76.8 |
| | 0.16 | 2.59 | 16.5 | 74.4 | 85.0 | 77.8 |
| E_GO | 0.08 | 2.42 | 15.8 | 76.1 | 84.2 | 81.2 |
| | 0.16 | 2.54 | 16.1 | 76.7 | 83.7 | 80.9 |
| E_GA | 0.08 | 2.57 | 16.2 | 72.6 | 83.2 | 78.5 |
| | 0.16 | 2.59 | 15.4 | 72.5 | 83.1 | 71.9 |

Table 2 shows the glass transition temperatures, T_{g}, from DSC analysis, E″ peak and tan δ peak temperatures, and storage tensile moduli, E′, from DMA, of neat epoxy and epoxy/graphene nanocomposites with various graphene weight fractions. E_Neat refers to a sample of neat epoxy with no nanofillers. The results from differential scanning calorimetry (DSC) measurements showed a similar trend to that from DMA. At a 0.16 wt % graphene loading, E_GO exhibited the highest glass transition temperatures, Tg, and E_GA the lowest Tg. Storage tensile moduli, E′, and Tg of neat epoxy and epoxy nanocomposites are listed in Table 2. Tg was estimated from the temperature at maximum tan δ (=E′/E″) as well as maximum loss modulus E″. Tg values from DSC analysis are also listed. A reduction of Tg, which is typically found in epoxy toughening by liquid rubbers or thermoplastic polymers, is absent. Rather, there was a small increase similar to other studies with graphene and epoxy.

Thermo-mechanical properties of E_graphene composites were studied with a dynamic temperature ramp from 25 to 150° C. (ramping rate=5° C. min⁻¹) using a RSA-G2 solids analyzer (TA Instruments). 3 mm wide and 4 cm long rectangular strips cut from the cured plates were dried in vacuum at room temperature and mounted between tensile fixtures. Dynamic tensile storage and loss moduli were measured at 1 rad s⁻¹. During each test, static pretension on the specimens was maintained at a frequency of 1 Hz under a dynamic strain of 0.004% with a pretension of 50 g force. For DSC measurements, 5 mg of sample was loaded into an aluminum pan and scanning was performed from −10° C. to 200° C. at the rate of 10° C. min⁻¹ after removing the thermal history with heating at 200° C. The Tg determination was based on the inflection point method using TA Universal Analysis software.

Flexural modulus and strength were measured using an RSA-G2 solids analyzer (TA Instruments) according to ASTM D790-10 at a span-to-thickness ratio of 16 and a crosshead rate of 0.25 mm min⁻¹ (0.01 min⁻¹ strain rate). Fracture behavior was measured with crack-opening tests on compact tension specimens according to ASTM D5045-99. A precrack with an average length of 2±0.6 mm was initiated by tapping a fresh liquid-N₂-chilled razor blade into the notch. Specimens were loaded to failure at 10 mm min⁻¹ using an Instron 3344 single column testing system equipped with a 5 kN load cell. At each weight fraction of graphene additives, we tested 15 different samples to check for reproducibility of the results, and then the mode-I critical-stress-intensity factor (K_{Ic}) and critical strain energy release rate (G_{Ic}) were calculated based on Equation 1 and 3, respectively. The mode-I critical-stress-intensity factor is defined as

$${K}_{Ic} = \frac{{P}_{Q}}{B \sqrt{W}} f ( x ) \qquad ( 1 )$$

where P_{Q} is the maximum loading force in the compact-tension test, B and W are sample thickness and characteristic length of the specimen, respectively. f(x) is the geometric factor, defined as

$$f ( x ) = \frac{( 2 + x ) ( 0.886 + 4.64 x - 13.22 {x}^{2} + 14.72 {x}^{3} - 5.6 {x}^{4} )}{{( 1 - x )}^{3 / 2}} \qquad ( 2 )$$

where x=a/W and a is the initial notch length including the precrack.

The mode-I critical strain energy release rate is defined as

$${G}_{Ic} = \frac{( 1 - {v}^{2} ) {K}_{Ic}^{2}}{E} \qquad ( 3 )$$

where E is the elastic modulus and v is the Poisson ratio of the epoxy, which is taken to be 0.34.

Table 3 includes data on the flexural modulus and strength of the epoxy/graphene nanocomposites. To manifest the effect at small loadings, the increment is 0.04 for x<0.1 and 0.1 for x>0.1.

TABLE 3

| | Graphene | Young's | Tensile | Fracture | Fracture |
|---|---|---|---|---|---|
| | loading/ | modulus | strength | toughness | energy |
| | wt % | (E)/GPa | (σ)/MPa | (K_{1C})/MPa m^{0.5} | (G_{1C})/J m⁻² |
| Neat epoxy | 0 | 2.57 ± 0.02 | 69.8 ± 2.3 | 0.97 ± 0.08 | 329.1 + 54.5 |
| E_GS1 | 0.01 | 2.62 ± 0.02 | 68.7 ± 0.5 | 1.08 ± 0.06 | 394.7 ± 47.2 |
| | 0.02 | 2.57 ± 0.03 | 67.3 ± 1.5 | 1.31 ± 0.11 | 595.0 ± 98.9 |
| | 0.03 | 2.52 ± 0.02 | 64.8 ± 0.3 | 1.11 ± 0.08 | 436.8 ± 64.1 |
| | 0.04 | 2.48 ± 0.04 | 64.3 ± 0.5 | 1.08 ± 0.13 | 426.6 ± 110.2 |
| | 0.08 | 2.60 ± 0.05 | 68.5 ± 0.3 | 1.16 ± 0.06 | 455.8 ± 51.2 |
| | 0.16 | 2.53 ± 0.02 | 68.4 ± 0.4 | 1.22 ± 0.08 | 519.1 ± 66.6 |
| | 0.30 | 2.56 ± 0.04 | 64.6 ± 0.2 | 1.26 ± 0.04 | 546.3 ± 33.2 |
| E_GS2 | 0.02 | 2.57 ± 0.01 | 64.4 ± 0.5 | 1.31 ± 0.10 | 592.6 ± 91.0 |
| | 0.04 | 2.52 ± 0.03 | 61.0 ± 1.4 | 1.32 ± 0.10 | 611.7 ± 91.3 |
| | 0.087 | 2.63 ± 0.02 | 65.8 ± 0.7 | 0.98 ± 0.05 | 323.7 ± 31.2 |
| | 0.16 | 2.47 ± 0.02 | 65.4 ± 0.9 | 0.99 ± 0.06 | 354.0 ± 47.5 |
| | 0.30 | 2.61 ± 0.01 | 60.5 ± 0.9 | 1.04 ± 0.07 | 365.1 ± 47.0 |
| E_GO | 0.02 | 2.60 ± 0.01 | 65.7 ± 0.6 | 1.07 ± 0.14 | 397.0 ± 104.1 |
| | 0.04 | 2.52 ± 0.02 | 61.9 ± 0.6 | 1.40 ± 0.06 | 685.4 ± 60.3 |
| | 0.08 | 2.48 ± 0.01 | 62.5 ± 1.8 | 1.28 ± 0.06 | 553.9 ± 51.9 |
| | 0.16 | 2.61 ± 0.03 | 61.6 ± 1.0 | 1.38 ± 0.05 | 646.2 ± 49.3 |
| | 0.32 | 2.61 ± 0.02 | 62.3 ± 0.3 | 1.41 ± 0.13 | 682.1 ± 127.1 |
| E_GA | 0.02 | 2.61 ± 0.02 | 62.1 ± 1.5 | 1.37 ± 0.08 | 635.3 ± 71.3 |
| | 0.04 | 2.60 ± 0.01 | 62.5 ± 0.8 | 1.52 ± 0.10 | 789.5 ± 107.5 |
| | 0.08 | 2.69 ± 0.03 | 61.9 ± 0.7 | 1.29 ± 0.07 | 551.1 ± 60.5 |
| | 0.16 | 2.71 ± 0.02 | 62.8 ± 0.4 | 1.24 ± 0.05 | 506.1 ± 38.0 |

### Example 23

### Preparation of oleyl-modified GO (“OA-GO”) and methacryloyl-modified GO (“GO-C═C”) nanofillers

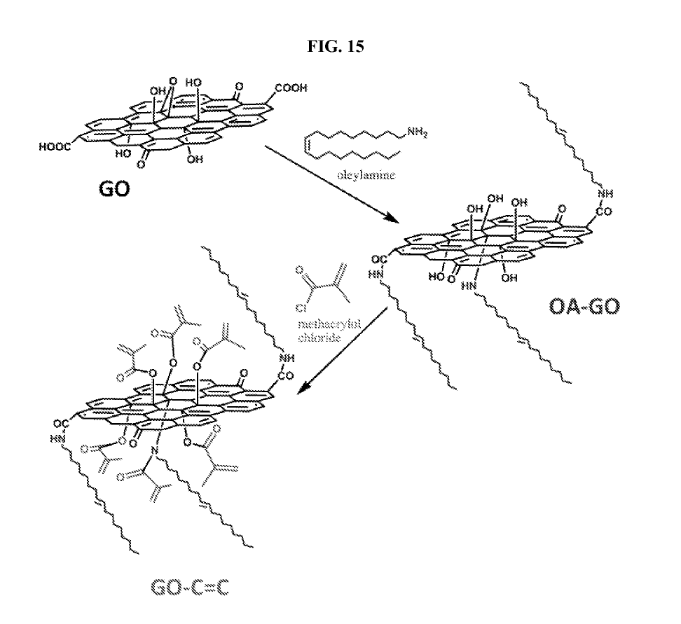

The scheme for the modification of graphene oxide is shown in FIG. 15. A mass of 200 mg of GO (synthesized from natural graphite according to the Hummers method as described in Example 21) was dispersed in 100 g of water, and then a 40 mL of ethanol solution with 0.15 g of oleylamine was added with vigorous stirring. The mixture was sonicated for 2 h and then stirred for 20 h in an oil bath maintained at 95° C. The precipitate was separated by centrifugation, washed with ethanol at least five times, and then dispersed in tert-butanol. Oleyl-modified graphene oxide (“OA-GO”) was obtained after freeze-drying the tert-butanol dispersion. It was dried in a vacuum oven at 60° C. for 6 h.

An amount of 100 mg OA-GO was dispersed in 50 mL of dimethyl formamide by bath sonication. The dispersion was then cooled down in an ice bath and purged with N₂ for 1 h. Triethylamine (1.0 mL) was then added while the dispersion was magnetically stirred, followed by the addition of 0.5 mL of methacryloyl chloride. The mixture was kept in an ice bath for another 2 h. After reaction at room temperature for 20 h, acetone was added to the mixture to flocculate the modified GO, and the solid product was collected by centrifugation at 4000 rpm for 15 min. The solid product was washed with acetone and ethanol and centrifuged at least 5 times, and then dispersed in tert-butanol. GO-C═C was obtained after freeze-drying the tert-butanol dispersion and further drying in a vacuum oven at 60° C. for 6 h.

Upon oxidation of graphite by the Hummers method, many oxygen-containing groups are generated on the graphene lattice, and the van der Waals attraction of graphene layers is decreased significantly due to the increased interlayer spacing from graphite to GO. The polar surface groups facilitate the dispersion of GO in water and other polar solvents, and they also provide reaction sites for further functionalization. As shown in FIG. 15, oleylamine can react either with epoxide groups based on a ring-opening reaction or with carboxyl groups based on amidation. The long-chain alkyl groups improve the compatibility between the GO surface with less polar polymer matrices, as reported previously in polymer-clay systems. Further reaction of methacryloyl chloride with hydroxyl and amine groups produces unsaturated bonds on the surface.

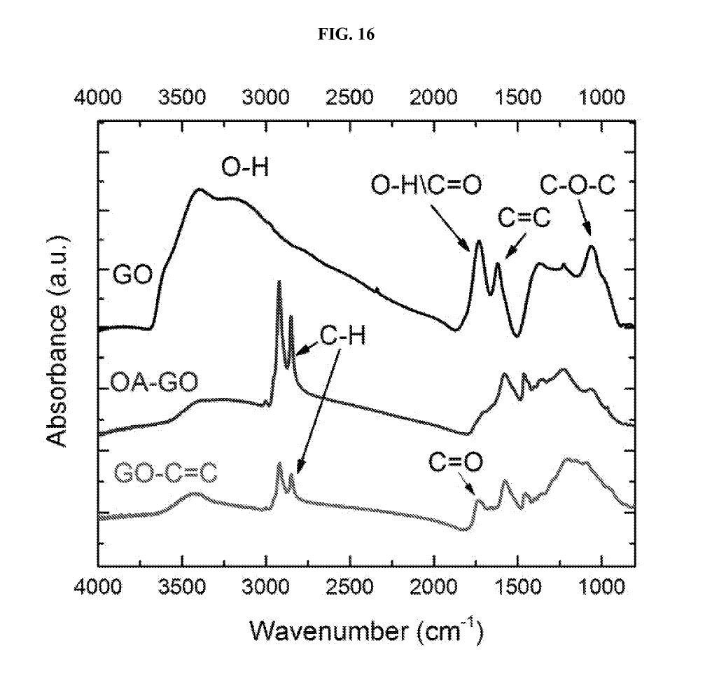

FT-IR and X-ray diffraction were used to monitor the modification process. Fourier transform-infrared (FT-IR) spectroscopy was carried out using a Nicolet Magna-IR 760 spectrometer. As shown in FT-IR spectra in FIG. 16, the O—H groups in GO contributed to strong absorption bands around 3400 cm⁻¹, 3190 cm⁻¹ (stretching) and 1720 cm⁻¹ (bending). C═C, C═O and C—O—C (epoxide) groups were also clearly identified from the peaks at 1720 cm⁻¹, 1616 cm⁻¹ and 1062 cm⁻¹, respectively. Reaction with oleylamine to OA-GO resulted in a decreased intensity of the C—O—C absorption at 1062 cm⁻¹ and the emergence of a C—H absorption at 2920 cm⁻¹ and 2850 cm⁻¹. No water was adsorbed on OA-GO due to its hydrophobicity, as shown by the significant decrease in O—H absorption. Esterification with methacryloyl chloride to GO-C═C was confirmed by the peak at 1732 cm⁻¹, which was assigned to the C═O vibration in ester groups. As for the C═C groups, it was difficult to resolve the contribution from oleyl and methacryloyl groups, because of the abundance of C═C groups in the graphene lattice.

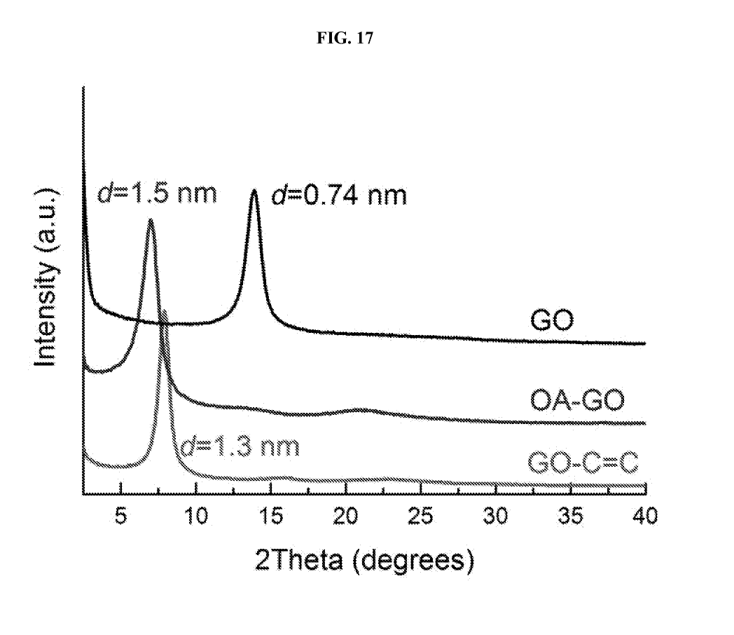

The modifications of GO created organic functional groups in between the nanosheets, and thus changed the d-spacing correspondingly. X-ray diffraction (XRD) patterns were acquired using a PANalytical X-Pert Pro MPD X-ray diffractometer equipped with a Co source (45 kV, 40 mA, λ=1.790 Å) and an X-Celerator detector. As shown in the XRD patterns in FIG. 17, after oleylamine modification, the d-spacing increased from GO (0.74 nm) to OA-GO (1.5 nm) due to the presence of long-chain oleyl groups at the interlayer space. Similar to organoclays modified with alkyl quaternary ammonium salts, the long alkyl chains are arranged in a paraffin-type array between hydrophilic GO sheets, given that the d-spacing (1.5 nm) is smaller than the chain length of oleyl group (2.3 nm). From OA-GO to GO-C═C, the d-spacing of GO-C═C was still maintained at a higher value than that of GO, although a slightly decrease compared to OA-GO was observed, which may be due to the removal of strongly absorbed oleylamine (shown by the intensity decrease of the C—H absorption from OA-GO to GO-C═C in FIG. 16).

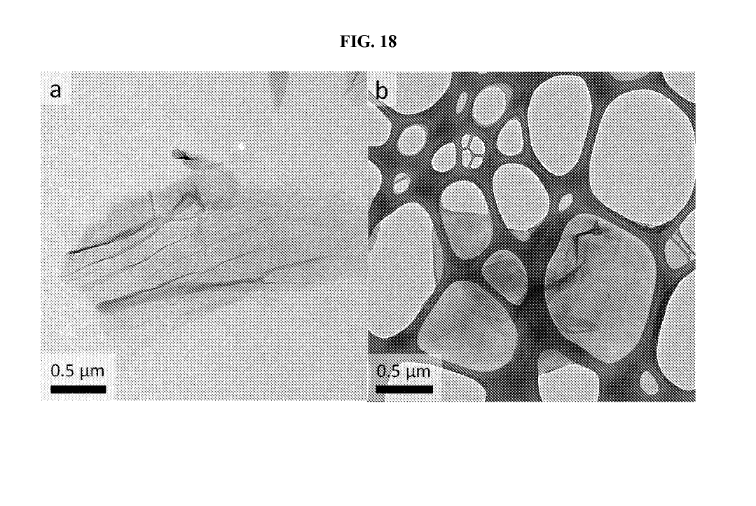

The morphology of GO nanosheets before and after the organic modification was characterized by TEM, with images shown in FIG. 18. Transmission electron microscopy (TEM) images were obtained on a FEI Tecnai T12 microscope using an accelerating voltage of 100 kV. Graphene samples were picked up on carbon-coated Cu grids from dispersions, and polymer samples were first microtomed (Leica Ultracut) at room temperature into 70 nm sections before being picked up on Cu grids. GO had been exfoliated into thin sheets with lateral dimensions of several micrometers (FIG. 18). Wrinkles can also be observed, which reveal the flexibility of the GO nanosheets. Any sp3-hybridized carbon atoms present introduce defects into the 2D planes, which also contribute to the wrinkled morphology. After organic modification, the morphology of GO-C═C (FIG. 18(b)) was similar to that of GO, indicating that the 2D morphology was maintained after modification and GO-C═C still maintained high aspect ratios.

### Example 24

### Synthesis and Characterization of UP-Graphene Nanocomposites

Nanocomposites of unsaturated polyester (“UP”) resin with graphene nanofillers from Example 23 were synthesized. The desired amount of GO or GO-C═C was added to UP resin (PCCR 718-6684-30, available from PCCR USA, Inc.; PCCR 718-6684 product with fume silica removed and cure time prolonged from 15 min to 30 min) in a glass jar, and the mixture was subjected to high intensity probe sonication with 4-s pulse on/2-s pulse off sequences and a total sonication time of 2 h at 40% amplitude. The glass jar was placed in a water bath at room temperature, and the sonication was paused when the temperature of the water bath exceeded 30° C. The apparatus was equipped with a condenser to prevent evaporation of styrene during sonication. After sonication, a calculated amount of Luperox® DDM-9 (a ketone peroxide from Arkema Inc.) was added into the mixture to give a weight ratio of DDM-9: UP resin of 1.5:100. The mixture was stirred at 300 rpm for 10 min and then degassed in a vacuum oven for another 5 min. After degassing, the mixture was poured into a glass mold and cured at room temperature for 1 day, at 70° C. for 3h, and at 120° C. for 3 h.

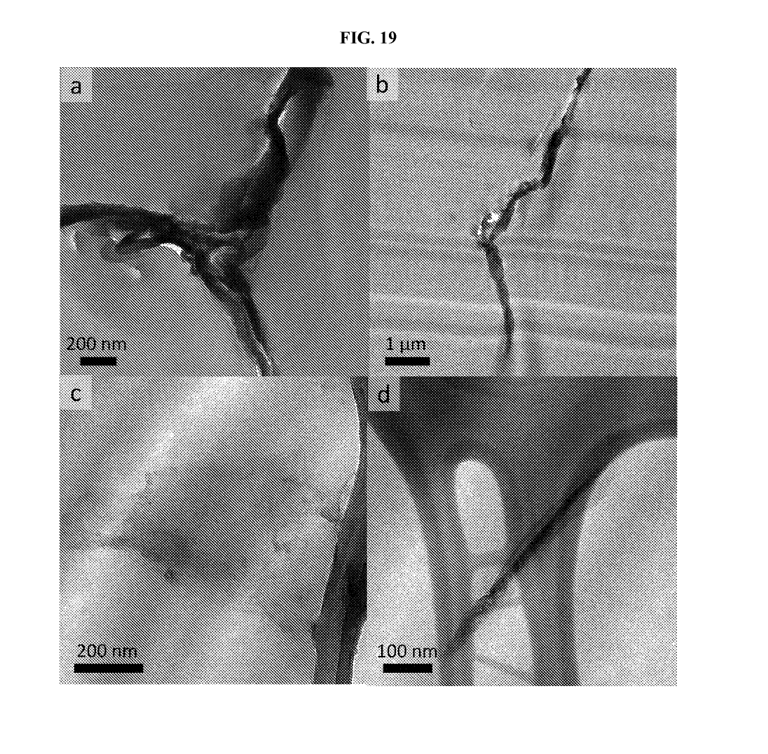

TEM was used to characterize the UP nanocomposites. Transmission electron microscopy (TEM) images were obtained on a FEI Tecnai T12 microscope using an accelerating voltage of 100 kV. Graphene samples were picked up on carbon-coated Cu grids from dispersions, and polymer samples were first microtomed (Leica Ultracut) at room temperature into 70 nm sections before being picked up on Cu grids. Although GO exfoliated in water very easily, it restacked and aggregated into large particles in the final composites. Although not limited to a particular theory, it is believed that this aggregation is a result of GO incompatibility with the UP resin, as shown in FIG. 19(a) and (b). The aggregated particles had thicknesses around several hundred nanometers, and compared to the original GO, they had substantially reduced aspect ratios. In contrast, GO-C═C nanosheets maintained large lateral dimensions after they were incorporated into UP, and the small thickness resulted in low contrast between GO-C═C and UP, as can be seen in FIG. 19(c) and (d). A certain extent of restacking also took place during processing, yet the thickness of GO-C═C in the composites was only around 20 nm, indicating that a much better dispersion with GO-C═C nanosheets in UP had been achieved. Although not limited to a particular theory, it is believed that the reason for better dispersion of GO-C═C is the organic modification of GO, which changed the surface properties to hydrophobic, making the sheets more compatible with the UP resin, so that they could be well dispersed after probe ultrasonication and maintained in a highly dispersed state in the polymer matrix after curing.

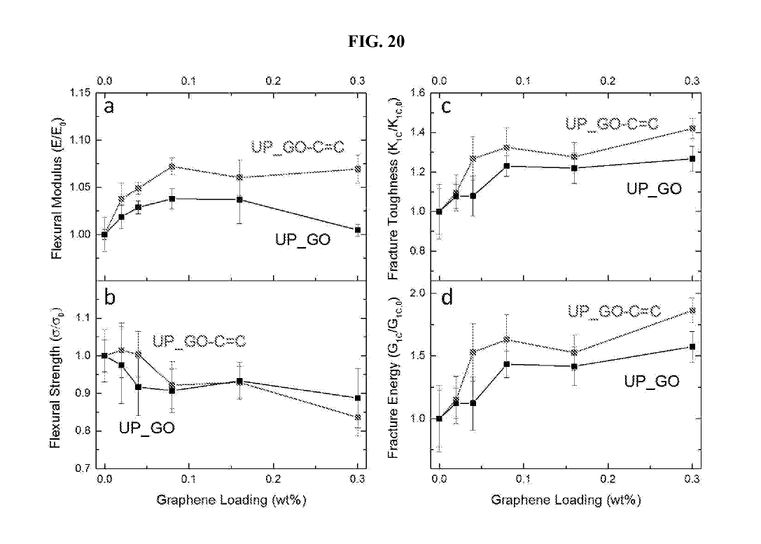

The relative mechanical properties of UP nanocomposites with GO and GO-C═C nanofillers (referred to as “UP_GO” and “UP_GO-C═C”, respectively) are summarized in FIG. 20. The methods and specimen geometries for measurements of flexural properties and fracture toughness are described in Example 22. The equations for the calculation of the mode-I critical-stress-intensity factor (K_{IC}) and the critical strain energy release rate (G_{IC}) are described in Example 22. In the calculations of G_{IC} for the samples in this Example, the Poisson ratio of the unsaturated polyester polymer was taken to be 0.39. Because the graphene content in the composites was small and UP is a glassy polymer, the change in modulus after incorporation of GO and GO-C═C was relatively small. Nonetheless, UP_GO-C═C showed a higher increase in flexural modulus than UP GO, due to better dispersion of GO-C═C in the composites. UP_GO-C═C also showed less decrease in flexural strength than UP_GO, indicating more effective load transfer from the polymer to graphene, owing to the strong covalently-bonded interface. More significant changes were observed in the fracture toughness and energy results, and the improvements for UP_GO-C═C were more significant than for UP_GO at all loading levels studied. The fracture toughness, K_{IC}, of UP_GO-C═C started to show a rapid increase at 0.04 wt % of graphene loading and then slowly increased at higher loading, whereas UP_GO showed the increase at 0.08 wt %, and then further improvement was very limited for higher loadings.

The onset of improvement in fracture properties for UP_GO-C═C at small graphene loadings is due to the better dispersion of GO-C═C in UP after organic functionalization and the stronger UP-graphene interface compared to UP_GO. At 0.04 wt % and 0.3 wt % of GO-C═C loadings, the improvements were 27% and 42% respectively for K_{IC}, and 53% and 86% respectively for G_{IC}, a parameter that is comparable to impact strength.

### Example 25

### Functionalization of Graphene Oxide Nanoparticles with TMI Isocyanate (“TMI-GO”)

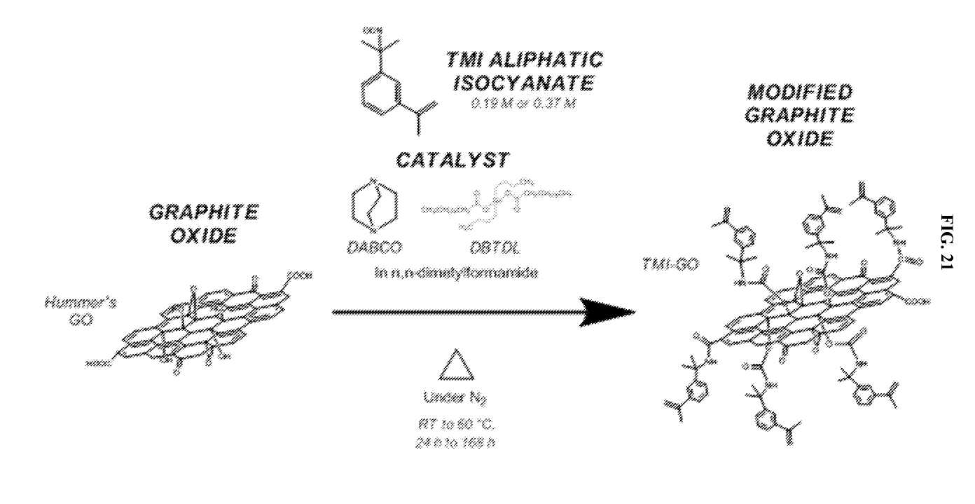

The basic synthesis scheme for “TMI-GO” nanofillers is depicted in FIG. 21, which depicts syntheses under various ranges of parameters. GO (synthesized from natural graphite according to the Hummers method as described in Example 21) was the starting material for all synthesis. In these syntheses, commercially available TMI isocyanate is covalently anchored onto the GO via reactions between the isocyanate and epoxides/hydroxyl functional groups on the surface of the GO. Once the covalent linkages are formed (either amides or urethanes), the surface of the GO is decorated with α-methylstyrene functionalities from the TMI isocyanate.

Nanofillers termed “TMI-GO-40° C.-1×” were synthesized by the following process. In a sealed glass vessel, 100 mg of graphite oxide and 25 mL of anhydrous n,n-dimethylformamide were stirred for 15 minutes. This mixture was then agitated in an ultrasonic bath for 1 hour. The mixture was transferred to a round bottom flask (RBF) and placed in an oil bath set at 40° C. A flow of nitrogen gas was used to continually purge the head space of the RBF. Magnetic stirring of the mixture was maintained at 300 RPM. After 2 hours of purging, 1 mL of 3-isopropenyl-α,α-dimethylbenzyl isocyanate (TMI isocyanate, from Allnex, 5 M concentration) was injected into the RBF, yielding a TMI isocyanate concentration of 0.19M in the total solution. The mixture was then heated and stirred for 24 hours. This was then quenched using 100 mL of dry toluene. Functionalized graphite oxide was separated from the other components of the reaction mixture by centrifugation. Portions of the quenched reaction mixture were spun down at 3000 RPM for 30 minutes. The supernatant was then removed. Three additional washing steps were conducted. For each step, dichloromethane or toluene was added, the suspension was spun at 3000 RPM for 30 minutes, and the clear (or light brown) supernatant was removed. After the last toluene washing step, tert-butanol was added to the pellets and the mixture was spun down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (−0.01 torr) for 24 hours, which allowed for the sublimation of any remaining tert-butanol. Brown powder of TMI-GO-40° C.-1× was obtained after the freeze-drying process.

Separately, nanofillers termed “TMI-GO-25° C.-1×” were synthesized by the process described in the prior paragraph, except that the oil bath was set at 25° C. instead of 40° C.

Nanofillers termed “TMI-GO-60° C.-2×-D” were synthesized by the following process. In a sealed glass vessel, 100 mg of graphite oxide, 25 mL of anhydrous n,n-dimethylformamide and 5 mg of 1,4-diazabicyclo[2.2.2]octane (DABCO) (Sigma-Aldrich, solid form (reagent plus grade (>99%))) were stirred for 15 minutes for synthesis of TMI-GO-60° C.-2×-D. This mixture was then agitated in an ultrasonic bath for 1 hour. The mixture was transferred to a round bottom flask and placed in an oil bath set at 60° C. A flow of nitrogen gas was used to continually purge the head space of the RBF. Magnetic stirring of the mixture was maintained at 300 RPM. After 2 hours of purging, 2 mL of 3-isopropenyl-α,α-dimethylbenzyl isocyanate (TMI isocyanate, from Allnex, 5 M concentration) was injected into the RBF, yielding a TMI isocyanate concentration of 0.37M in the total solution. The mixture was then heated and stirred for 24 hours. This was then quenched using 100 mL of dry methylene chloride. Functionalized graphite oxide was separated from the other components of the reaction mixture by centrifugation. Portions of the quenched reaction mixture were spun down at 3000 RPM for 30 minutes. The supernatant was then removed. Three additional washing steps were conducted. For each step, dichloromethane or toluene was added, the suspension was spun at 3000 RPM for 30 minutes, and the clear (or light brown) supernatant was removed. After the last washing step, tert-butanol was added to the pellets and the mixture was stirred down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (˜0.01 torr) for 24 hours, which allowed for the sublimation of any remaining tert-butanol. Brown powders of TMI-GO-60° C.-2×-D were obtained after the freeze-drying process.

Separately, nanofillers termed “TMI-GO-60° C.-2×-Sn” were synthesized by the process described in the prior paragraph except that the 5 mg of 1,4-diazabicyclo[2.2.2]octane (DABCO) was replaced with 5 mg of dibutyltin dilaurate (DBTDL) (Sigma-Aldrich, 95% purity) for the synthesis.

### Example 26

### Functionalization of Graphene Oxide Nanoparticles with TMI Isocyanate and Alkylamines

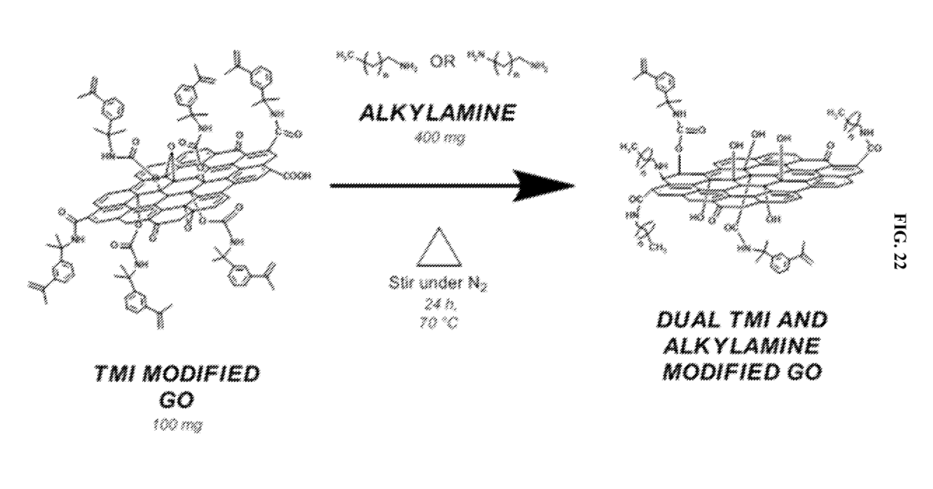

Utilizing the TMI-GO nanofillers of Example 25 as starting material, various dual synthesis schemes were completed to further functionalize TMI-GO nanofillers with alkyl functional groups. Such synthesis is depicted generally in FIG. 22. Extant functional groups on the TMI-GO react with primary alkylamines under appropriate reaction conditions. After functionalization, the new GO material contains both α-methylstyrene functionalities from the TMI isocyanate and alkyl functionalities.

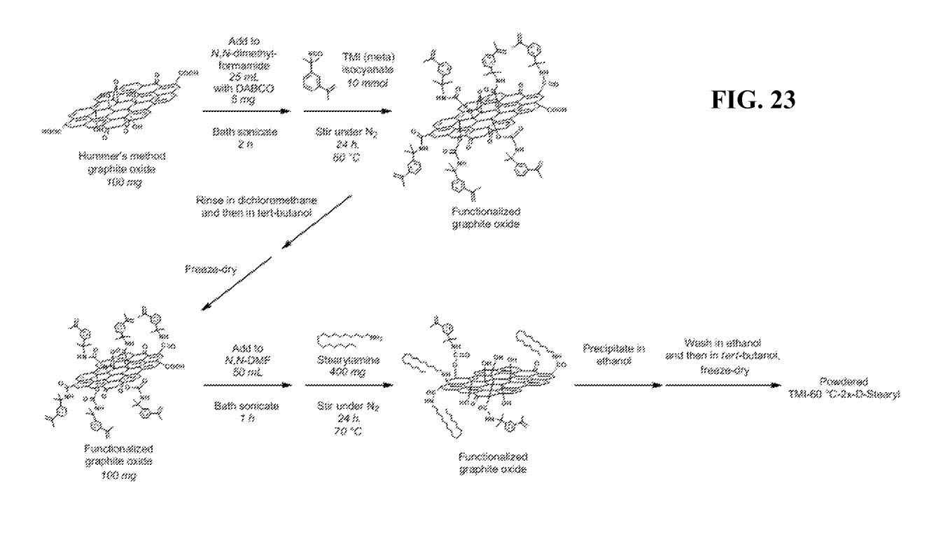

Nanofillers termed “TMI-GO-60° C.-2×-D-Stearyl” were synthesized by the following process. The entire process, encompassing the prior steps described in Example 25, is shown in FIG. 23. In a sealed glass vessel, 100 mg of the TMI-GO-60° C.-2×-D, 50 mL of anhydrous n,n-dimethylformamide, and 400 mg of octadecylamine (stearylamine) were stirred for 15 minutes. This mixture was then agitated in an ultrasonic bath for 1 hour. If visible pieces of solid octadecylamine were still present in the mixture, an additional 1 hour of sonication was conducted. The mixture was transferred to a round bottom flask and the head space was continually purged with a flow of nitrogen. The round bottom flask was immersed in an oil bath heated to 70° C. and stirred at 300 RPM using a magnetic stir bar. Heating and stirring was maintained for 24 hours and then the reaction was quenched with 150 mL of 200-proof ethanol. The graphite oxide was separated from the other components of the reaction mixture by centrifugation. Portions of the quenched reaction mixture were spun down at 3000 RPM for 30 minutes. The supernatant was then removed. Two additional washing steps were conducted. For each step, ethanol was added, the suspension was spun at 3000 RPM for 30 minutes, and the clear supernatant was removed. After the last washing step, tert-butanol was added to the pellets and the mixture was stirred down for 15 minutes at 3000 RPM. The tert-butanol was removed and an additional portion was added. This suspension was spun down for 15 minutes at 3000 RPM, the supernatant was removed, and the pellets were frozen in a cryogen. These pellets were then evacuated in low vacuum (−0.01 torr) for 24 hours, which allowed for the sublimation of any remaining tert-butanol. Black powders TMI-GO-60° C.-2×-D-Stearyl were obtained after the freeze-drying process.

This synthesis is not limited to the use of octadecylamine. Other alkylamines (including dodecylamine and octylamine) can be utilized for the functionalization in the same fashion.

### Example 27

### Synthesis and Characterization of UP-graphene Nanocomposites

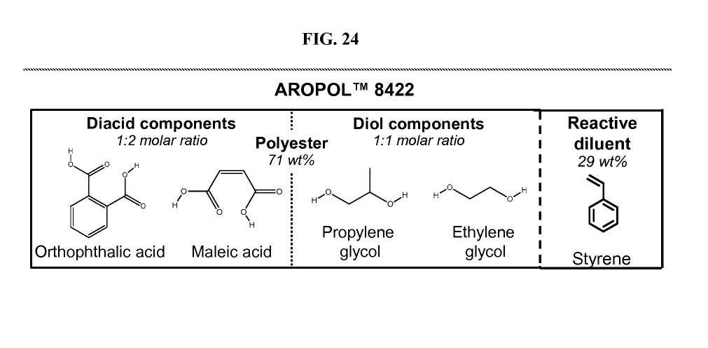

Nanocomposites were synthesized from UP resins with select nanofillers of Examples 25 and 26. For the following systems, the unsaturated polyester resin AROPOL™ 8422 was used. AROPOL 8422 is a neat resin system commercially available from Ashland Inc. The composition of the resin is depicted in FIG. 24. It contains 29 wt % styrene that was diluted to 45 wt % styrene or diluted to 29 wt % styrene and 16 wt % methyl methacrylate (MMA). The resin was promoted with Sigma-Aldrich cobalt(II) 2-ethylhexanoate (65 wt % in mineral spirits), 0.0185 g per 100 g of diluted resin. The resin was inhibited with Sigma-Aldrich 4-tert-butylcatechol (>98%); 0.050 g per 100 g of diluted resin. The radical polymerization was initiated with 1.25 g Luperox® DDM-9 per 100 g of diluted resin. Other UP resins can also be used with the nanofillers, such as Interplastic Corporation's CoREZYN COR45-BA-041W, an orthophthalic acid polyester resin.

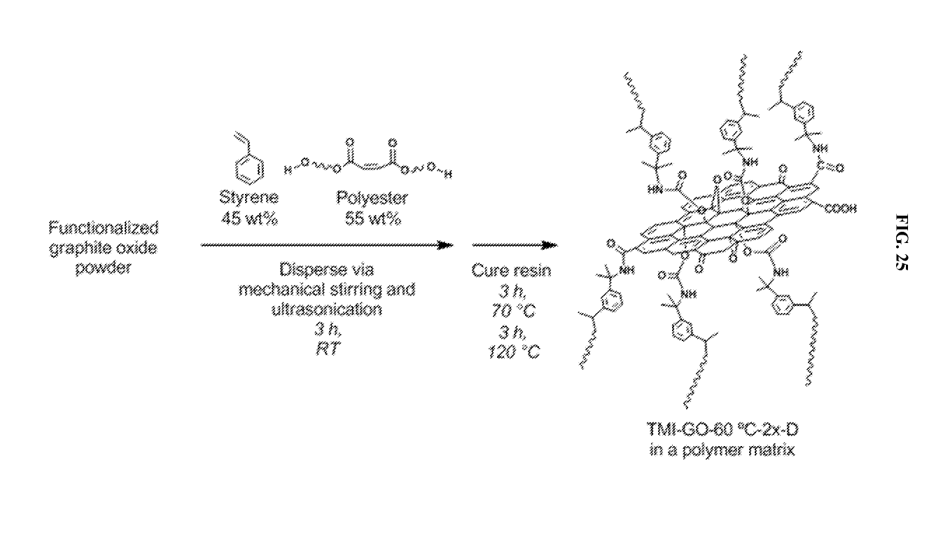

Following one synthesis scheme, depicted in FIG. 25, nanocomposites were made with TMI-GO nanofillers in UP resin with 45% styrene diluent. The desired amount of TMI-GO nanofillers was added to UP resin diluted to 45 wt % styrene, and the mixture was subjected to mechanical stirring and ultrasonication at room temperature for 3 h. After sonication, a calculated amount of Luperox® DDM-9 was added into the mixture to give a weight ratio of DDM-9:UP resin of 1.25:100. The mixture was poured into a glass mold and cured at room temperature for 1 day, at 70° C. for 3 h, and at 120 ° C. for 3 h.

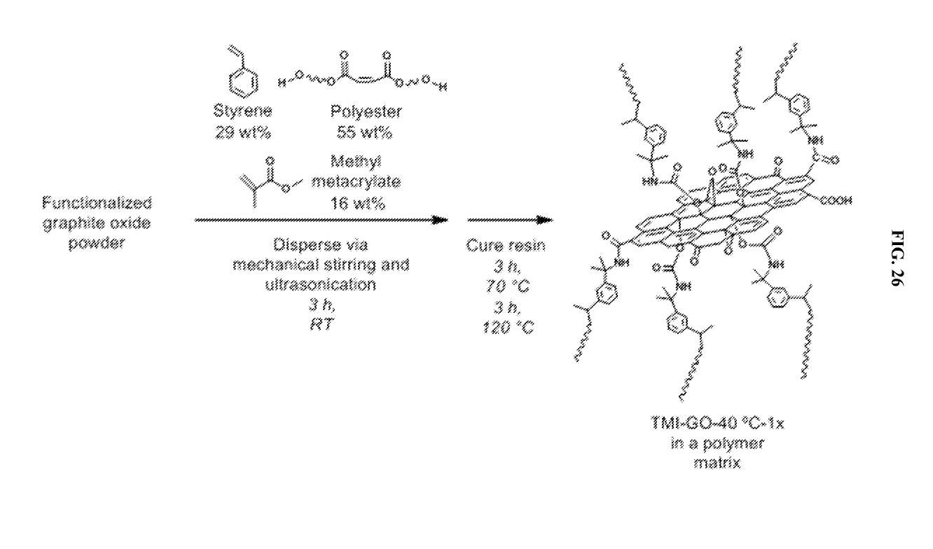

Following another synthesis scheme, depicted in FIG. 26, nanocomposites were made with TMI-GO-40° C.-1× nanofillers in UP resin with 29% styrene +16% MMA mixed diluent. The desired amount of TMI-GO nanofillers was added to UP resin diluted to 29 wt % styrene and 16 wt % methyl methacrylate, and the mixture was subjected to mechanical stirring and ultrasonication at room temperature for 3 h. After sonication, a calculated amount of Luperox® DDM-9 was added into the mixture to give a weight ratio of DDM-9:UP resin of 1.25:100. The mixture was poured into a glass mold and cured at room temperature for 1 day, at 70° C. for 3 h, and at 120° C. for 3 h.

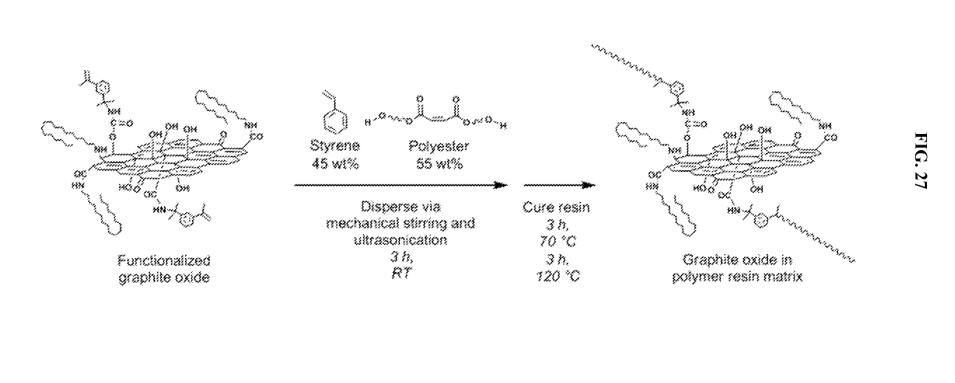

Following another synthesis scheme, depicted in FIG. 27, nanocomposites were made with TMI-GO-60° C.-2×-D-Stearyl nanofiller in UP resin with 45% styrene diluent. The desired amount of TMI-GO nanofillers was added to UP resin diluted to 45 wt % styrene, and the mixture was subjected to mechanical stirring and ultrasonication at room temperature for 3 h. After sonication, a calculated amount of Luperox® DDM-9 was added into the mixture to give a weight ratio of DDM-9:UP resin of 1.25:100. The mixture was poured into a glass mold and cured at room temperature for 1 day, at 70° C. for 3 h, and at 120° C. for 3 h.

Following another synthesis processes, nanocomposites were made using a fast-cure process, in which the inhibitor (4-tert-butylcatechol) concentration was reduced by 66%; 0.0167 g per 100 g of diluted resin, the initiator content was increased by 50% to 1.875 g Luperox® DDM-9 per 100 g of diluted resin, and the promoter concentration was kept the same. This altered procedure led to curing in ˜90 min, instead of ˜6 h as in the standard cure.

UP nanocomposites made by these synthesis methods were characterized using the methods and specimen geometries for measurements of flexural properties and fracture toughness as described in Example 22. The equations for the calculation of the mode-I critical-stress-intensity factor (K_{IC}) and the critical strain energy release rate (G_{IC}) are also shown in Example 22. In the calculations of G_{IC} for the samples in this Example, the Poisson ratio of the AROPOL™ 8422 unsaturated polyester resin was taken to be 0.39.

The mechanical properties of the nanocomposites samples made as described herein are shown in Table 4, in which the final numerals in the sample names denote the weight percentage of graphene loading. For example, in “UP_TMI-GO-40° C.-1×_{—}02” the “02” denotes a 0.02% wt % graphene nanofiller content. In Table 4, the values in parentheses are standard deviations from 5 samples (for 6 and E) or 10 samples (for K_{IC} and G_{IC}). “UP_GO” indicates nanocomposites made with unfunctionalized graphene oxide nanofiller. “UP_AND” indicates nanocomposites made with graphene (Angstron Materials N006-P, 10-20 nm thickness, ˜14 μm size, carbon content ˜97%, oxygen content ˜1.5%, surface area ≦21 m²g⁻¹).

TABLE 4

| | Flexural | Flexural | Fracture | Fracture | Additional notes on |
|---|---|---|---|---|---|
| | Strength, | Modulus, | toughness, | energy, | UP resin and curing |
| Samples | σ (MPa) | E (GPa) | K_{IC} (J m⁻²) | G_{IC} (J m⁻²) | method |
| Neat AROPOL | 118 (6) | 3.64 (0.04) | 0.65 (0.03) | 98 (9) | 45 wt % styrene, |
| 8422 Plate | | | | | standard cure |
| UP_TMI-GO- | 112 (6) | 3.61 (0.03) | 0.79 (0.05) | 147 (17) | 45 wt % styrene, |
| 40° C.-1x_02 | | | | | standard cure |
| Styrene | | | | | |
| UP_TMI-GO- | 111 (3) | 3.54 (0.04) | 0.90 (0.05) | 196 (20) | 45 wt % styrene, |
| 40° C.-1x_04 | | | | | standard cure |
| Styrene | | | | | |
| UP_TMI-GO- | 85 (7) | 3.63 (0.22) | 0.81 (0.15) | 159 (54) | 45 wt % styrene, |
| 40° C.-1x_08 | | | | | standard cure |
| Styrene | | | | | |
| UP_TMI-GO- | 116 (6) | 3.75 (0.05) | 0.88 (0.07) | 177 (27) | 29% styrene/16% |
| 40° C.-1x_02 | | | | | MMA, standard |
| Styrene + MMA | | | | | cure |
| UP_TMI-GO- | 100 (5) | 3.94 (0.03) | 1.00 (0.08) | 217 (37) | 29% styrene/16% |
| 40° C.-1x_04 | | | | | MMA, standard |
| Styrene + MMA | | | | | cure |
| UP_TMI-GO- | 96 (3) | 3.93 (0.10) | 1.00 (0.09) | 218 (40) | 29% styrene/16% |
| 40° C.-1x_08 | | | | | MMA, standard |
| Styrene + MMA | | | | | cure |
| UP_TMI-GO- | 118 (2) | 3.50 (0.02) | 0.80 (0.05) | 154 (18) | 45 wt % styrene, |
| 60° C.-2x-D_02 | | | | | standard cure |
| Styrene | | | | | |
| UP_TMI-GO- | 106 (1) | 3.50 (0.01) | 0.84 (0.07) | 172 (27) | 45 wt % styrene, |
| 60° C.-2x-D_04 | | | | | standard cure |
| Styrene | | | | | |
| UP_TMI-GO- | 96 (3) | 3.51 (0.02) | 0.85 (0.05) | 176 (22) | 45 wt % styrene, |
| 60° C.-2x-D_08 | | | | | standard cure |
| Styrene | | | | | |
| UP_TMI-GO- | 115 (4) | 3.50 (0.01) | 0.91 (0.07) | 198 (29) | 45 wt % styrene, |
| 60° C.-2x-Sn_02 | | | | | standard cure |
| Styrene | | | | | |
| UP_TMI-GO- | 90 (19) | 3.75 (0.14) | 0.80 (0.11) | 148 (40) | 45 wt % styrene, |
| 60° C.-2x-Sn_04 | | | | | standard cure |
| Styrene | | | | | |
| UP_TMI-GO- | 123 (3) | 3.65 (0.02) | 0.85 (0.04) | 167 (16) | 45 wt % styrene, |
| 60° C.-2x- | | | | | standard cure |
| Stearyl_02 | | | | | |
| Styrene | | | | | |
| UP_TMI-GO- | 97 (4) | 3.71 (0.04) | 0.87 (0.09) | 174 (34) | 45 wt % styrene, |
| 60° C.-2x- | | | | | standard cure |
| Stearyl_04 | | | | | |
| Styrene | | | | | |
| UP_TMI-GO- | 97 (2) | 3.60 (0.02) | 0.96 (0.05) | 219 (25) | 45 wt % styrene, |
| 60° C.-2x- | | | | | standard cure |
| Stearyl_08 | | | | | |
| Styrene | | | | | |
| UP_TMI-GO- | 105 (4) | 3.70 (0.03) | 0.78 (0.08) | 147 (27) | 45 wt % styrene, |
| 60° C.-2x- | | | | | fast cure |
| Stearyl_04_F/C | | | | | |
| Styrene | | | | | |
| UP_TMI-GO- | 102 (4) | 3.59 (0.10) | 0.83 (0.06) | 166 (26) | 45 wt % styrene, |
| 60° C.-2x- | | | | | fast cure |
| Stearyl_08_F/C | | | | | |
| Styrene | | | | | |
| UP_TMI-GO- | 107 (7) | 3.83 (0.02) | 0.72 (0.04) | 114 (11) | 45 wt % styrene, |
| 60° C.-2x- | | | | | fast cure |
| Stearyl_15_F/C | | | | | |
| Styrene | | | | | |
| UP_TMI-GO- | 96 (5) | 3.92 (0.01) | 0.85 (0.05) | 157 (17) | 45 wt % styrene, |
| 60° C.-2x- | | | | | fast cure |
| Stearyl_20_F/C | | | | | |
| Styrene | | | | | |
| UP_GO_02 | 119 (5) | 3.60 (0.03) | 0.95 (0.04) | 213 (17) | 45 wt % styrene, |
| Styrene | | | | | standard cure |
| UP_GO_04 | 121 (4) | 3.59 (0.02) | 0.83 (0.05) | 161 (18) | 45 wt % styrene, |
| Styrene | | | | | standard cure |
| UP_GO_08 | 98 (10) | 3.61 (0.04) | 0.89 (0.04) | 188 (19) | 45 wt % styrene, |
| Styrene | | | | | standard cure |
| UP_GO_15 | 99 (9) | 3.88 (0.04) | 0.83 (0.05) | 150 (17) | 45 wt % styrene, |
| Styrene | | | | | standard cure |
| UP_AND_02 | 120 (5) | 3.61 (0.03) | 0.79 (0.05) | 146 (18) | 45 wt % styrene, |
| Styrene | | | | | standard cure |
| UP_AND_04 | 119 (5) | 3.57 (0.03) | 0.92 (0.03) | 200 (12) | 45 wt % styrene, |
| Styrene | | | | | standard cure |
| UP_AND_08 | 118 (3) | 3.47 (0.05) | 0.87 (0.09) | 187 (38) | 45 wt % styrene, |
| Styrene | | | | | standard cure |

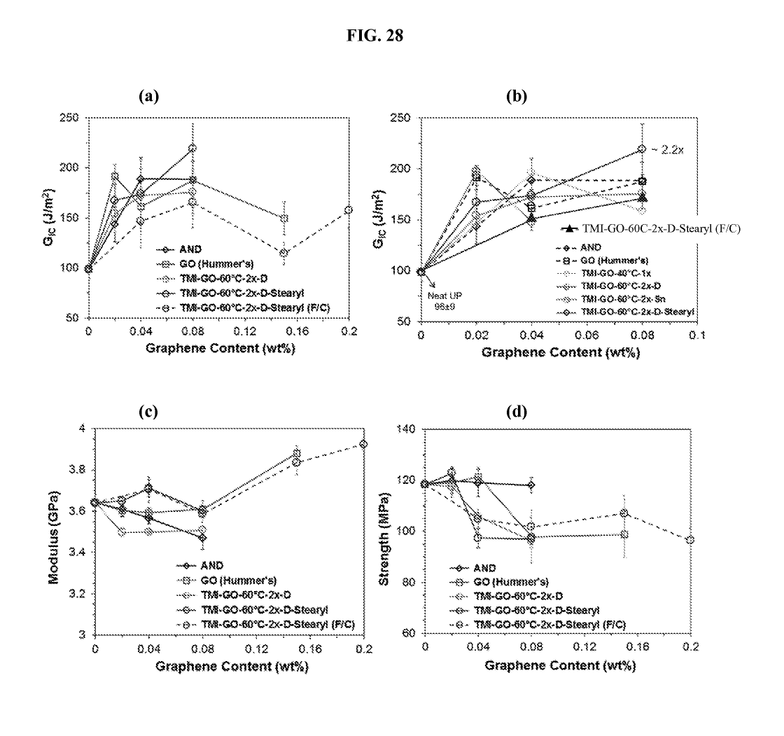

FIG. 28 contains plots of toughness, modulus, and strength data for different nanocomposites with different wt % graphene content. In FIGS. 28(a) and 28(b) TMI-GO-Stearyl samples are seen with higher G_{IC}; although not limited to a particular theory, it is believed that the higher G_{IC} resulted from stronger nanofiller-matrix interfaces. FIG. 28(c) shows that the composites with TMI-GO-60° C.-2×-D-Stearyl or unfunctionalized GO nanofillers showed an increase in flexural modulus at higher nanofiller loading weight percentages. FIG. 28(d) shows that at high loading, flexural strength of the composites remains steady when using TMI-GO-60° C.-2×-D-Stearyl or unfunctionalized GO nanofillers.

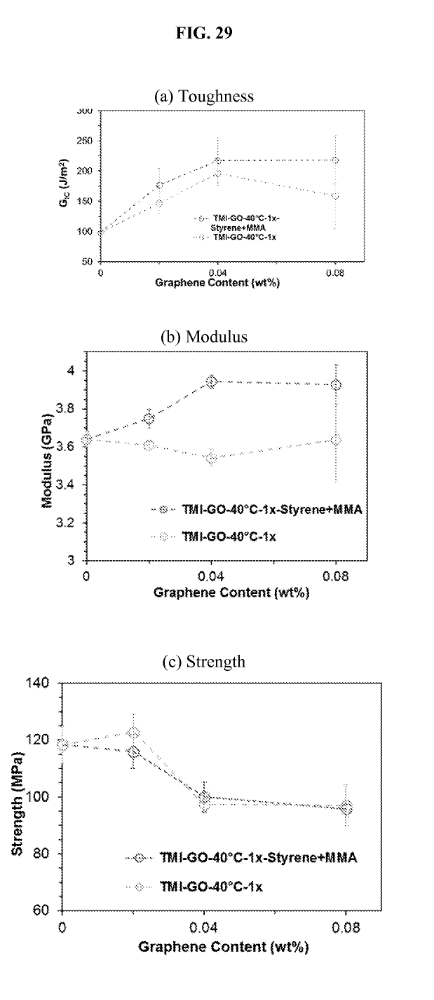

FIG. 29 contains plots of toughness, flexural modulus, and flexural strength data for nanocomposites using TMI-GO-40° C.-1× nanofiller in UP resin diluted to 45 wt % styrene and nanocomposites using the same nanofiller in UP resin with mixed diluent of 29 wt % styrene and 16 wt % methyl methacrylate. FIG. 29(a) shows that the mixed diluent system offered significant improvement in fracture toughness. G_{IC} improves by ca. 2.2× at 0.04 wt % of graphene nanofiller, even without the dual functionalization with alkylamines used in other samples of this Example. It was observed that samples made in the mixed diluent system had improved dispersion, with no macroscopic flecks present in the plate. FIG. 29(b) shows that flexural modulus was improved by ca. 10% in the mixed diluent system and slightly lowered in the styrene diluent system.

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

1-106. (canceled)

107. A oligomer-grafted nanofiller composition for disposition in a polymer matrix, the polymeric matrix comprising polymers derived from a plurality of polymerizable units, the nanofiller composition comprising:
a nanoparticle;
one or more coupling groups bonded to the nanoparticle; and
one or more oligomers bonded to the one or more coupling groups, wherein the oligomers are derived from two or more polymerizable units, at least one polymerizable unit being at least substantially similar to at least one of the polymerizable units of the polymer matrix, wherein
the nanoparticle comprises a graphene oxide nanoparticle, a graphite oxide nanoparticle, or a combination thereof;
the one or more oligomers comprises TMI isocyanate, an alkylamine, or a combination thereof; and
the plurality of polymerizable units of the polymer matrix comprise an unsaturated polyester, styrene, methyl methacrylate, or a combination thereof.

108. A oligomer-grafted nanofiller composition for disposition in a polymer matrix, the polymeric matrix comprising two or more polymerizable units, the nanofiller composition comprising:
a nanoparticle;
one or more coupling groups bonded to the nanoparticle; and
one or more oligomers bonded to the one or more coupling groups, wherein the oligomer comprises two or more polymerizable units and improves dispersion, interfacial strength, or both dispersion and interfacial strength between the nanoparticle and the polymer matrix, wherein
the nanoparticle comprises a graphene oxide nanoparticle, a graphite oxide nanoparticle, or a combination thereof; and
the one or more oligomers comprises TMI isocyanate, an alkylamine, or a combination thereof.

109. A composite comprising:
a polymer matrix; and
one or more oligomer-grafted nanofillers dispersed within the polymer matrix, wherein the oligomer-grafted nanofiller comprises a nanoparticle, one or more coupling groups bonded to the nanoparticle, and one or more oligomers bonded to the one or more coupling groups, wherein
the nanoparticle comprises a graphene oxide nanoparticle, a graphite oxide nanoparticle, or a combination thereof;
the one or more oligomers comprises TMI isocyanate, an alkylamine, or a combination thereof; and
the polymer matrix comprises a plurality of polymerizable units, the plurality of polymerizable units comprising an unsaturated polyester, styrene, methyl methacrylate, or a combination thereof.

110. The method for making an oligomer-grafted nanofiller comprising:
reacting a nanoparticle with one or more coupling agent to form a coupling agent-bonded nanoparticle; and
reacting the coupling agent-bonded nanoparticle with one or more oligomers to form the oligomer-grafted nanofiller,
wherein the one or more oligomers comprises TMI isocyanate, an alkylamine, or a combination thereof.

111. A method for depositing oligomer-grafted nanofiller in a polymer matrix comprising:
dispersing the oligomer-grafted nanofiller in the polymer matrix,
wherein the polymer matrix comprises one or more polymerizable units;
wherein the oligomer-grafted nanofiller comprises a nanoparticle and one or more oligomers covalently bonded to the nanoparticle, optionally through a coupling agent; and wherein the one or more oligomers are derived from two or more polymerizable units, wherein the one or more oligomers improve dispersion, interfacial strength, or both dispersion and interfacial strength between the nanoparticle and the polymer matrix, wherein
the nanoparticle comprises a graphene oxide nanoparticle, a graphite oxide nanoparticle, or a combination thereof;
the two or more polymerizable units from which the one or more oligomers are derived comprise TMI isocyanate and one or more alkylamines;
the one or more polymerizable units of the polymer matrix comprise an unsaturated polyester, styrene, methyl methacrylate, or a combination thereof.

112. A method for making a composite, comprising:
dispersing an oligomer-grafted nanofiller in a polymer matrix,
wherein the polymer matrix comprises one or more polymerizable units;
wherein the oligomer-grafted nanofiller comprises a nanoparticle and one or more oligomers covalently bonded to the nanoparticle, optionally through a coupling agent; and
wherein the one or more oligomers are derived from two or more polymerizable units, at least one polymerizable unit being at least substantially similar to at least one of the polymerizable units of the polymer matrix; and effectuating bonding between the oligomers and the polymer matrix, wherein
the nanoparticle comprises a graphene oxide nanoparticle, a graphite oxide nanoparticle, or a combination thereof;
the two or more polymerizable units from which the one or more oligomers are derived comprise TMI isocyanate and one or more alkylamines;
the one or more polymerizable units of the polymer matrix comprise an unsaturated polyester, styrene, methyl methacrylate, or a combination thereof.

113. A method for making a composite, comprising:
dispersing an oligomer-grafted nanofiller in a fluid comprising one or more monomers, the oligomer portion of the oligomer-grafted nanofiller being derived from at least one polymerizable unit corresponding to the one or more monomers; and
polymerizing the monomer, wherein
the one or more monomers comprises an unsaturated polyester, styrene, methyl methacrylate, or a combination thereof.

114. An oligomer-grafted nanofiller composition for disposition in a polymer matrix, the polymeric matrix comprising polymers derived from a plurality of polymerizable units, the nanofiller composition comprising:
a nanoparticle;
one or more coupling groups bonded to the nanoparticle; and one or more oligomers bonded to the one or more coupling groups, wherein the oligomers are derived from two or more polymerizable units, at least one polymerizable unit being at least substantially similar to at least one of the polymerizable units of the polymer matrix, wherein
the nanoparticle comprises a graphene oxide nanoparticle, a graphite oxide nanoparticle, or a combination thereof;
the one or more oligomers comprises oleyl, methacryloyl, or a combination thereof; and
the plurality of polymerizable units of the polymer matrix comprise an unsaturated polyester, styrene, methyl methacrylate, or a combination thereof.

115. An article made from an oligomer-grafted nanofiller composite according to claim 107.
